(19) United States
(12) Patent Application Publication
(10) Pub. No.: US 2024/0206459 A1
(43) Pub. Date: Jun. 27, 2024

(54) SYNERGISTIC AGROCHEMICAL OIL DISPERSION FORMULATION

(71) Applicant: RAJDHANI PETROCHEMICALS PRIVATE LIMITED, Ahmedabad, Gujarat (IN)

(72) Inventors: Dipakkumar PATEL, Ahmedabad, Gujarat, (IN); Kenal V. SHAH, Ahmedabad, Gujarat, (IN); Bhavesh V. SHAH, Ahmedabad, Gujarat, (IN); Kawarlal DABHODIA, Ahmedabad, Gujarat, (IN)

(21) Appl. No.: 18/290,028

(22) PCT Filed: Apr. 20, 2022
(86) PCT No.: PCT/IN2022/050377

§ 371 Date: Nov. 9, 2023

(30) Foreign Application Priority Data
Apr. 20, 2021 (IN) 202111018328

(51) Int. Cl. A01N 25/04; A01N 39/02; A01N 43/56; A01N 43/653; A01N 43/90; A01P 7/04

(52) U.S. Cl. CPC A01N 25/04; A01N 39/02; A01N 43/56; A01N 43/653; A01N 43/90; A01P 7/04

(57) ABSTRACT

Synergistic agrochemical oil dispersion (OD) formulation. More particularly the present invention relates to a novel agrochemical synergistic Oil Dispersion formulation comprising at least one active ingredient suspended in an oil phase. The present invention further relates to (OD) formulation provides increase in the synergistic activities between active ingredients and has thermal and chemical stability over a broad range of conditions. The present invention further relates to process of preparation of the oil dispersion formulation and its application in the field of agriculture.

### FIELD OF INVENTION

The present invention relates to a novel formulation for the agriculture application. More particularly the present invention relates to a novel agrochemical synergistic Oil Dispersion formulation comprising at least one active ingredient suspended in an oil phase. The present invention further relates to selection of suitable formulation excipients, process of preparation of the oil dispersion formulation and its application in the field of agriculture.

### BACKGROUND OF THE INVENTION

Various kinds of agrochemical formulations are developed based upon active ingredients and scope of application thereof. Pesticides for agriculture purpose are available both in the pure form and as well as incorporated into agrochemical formulations, which typically comprise one or more active ingredients (AIs) and additional excipients substances that enhance the effects and facilitate the application thereof, such as carriers, adjuvants or additives. These formulations can be directly applied onto the crops or, more commonly, are applied after being diluted and the spray mixture formed. The formulation type to be used is primarily defined on the basis of physicochemical characteristics of the AI(s) and can be: soluble concentrate (SL), emulsifiable concentrate (EC), emulsion in water (EW), suspension concentrate (SC), suspo-emulsion (SE), micro-emulsion (ME), oil dispersion (OD) or suspension concentrate (SC), dispersible concentrate (DC), capsule suspension (CS), dispersible granules (WG), wettable powder (WP) and others.

The various types of agrochemical formulations are the result of the existence of a large variety of AIs of different chemical natures. For example, a water soluble AI can be easily included into a water based SL while a high melting, water insoluble AI is commonly found in the form of a SC. For this reason, agrochemical formulations are distinct and can contain different inert components.

These days cultivation of crops and agriculture in general is cost intensive. Receiving a high yield from the cultivated crops is a key. Hence, to achieve higher yield, protecting crops from pest and parasitic infestation is vital. Hence the most effective way to control crop pests is the application of pesticides in accordance with the appropriate management practices with proper formulation thereof.

Treating plants with such a pesticides and plant health additives or combination thereof in appropriate formulation helps to reduce the agriculture damage. Another advantage of treating the plants with the said combination is the improvement in plant growth overall plant health and increase in the agricultural yield.

In recent years, OD formulations have been the subject of studies by companies and formulators because of their advantages with respect to the agronomic performance in the field as compared with conventional formulations. Active ingredients (AIs) formulated in different types of formulations usually exhibit different physicochemical characteristics based on type of formulation they are incorporated in. The different performance between them is due to the fact that ODs already contain in their composition oil, such as a mineral or vegetable oil, and emulsifiers, which can act as penetration adjuvants when applied in the field. Penetration adjuvants aid in the absorption of AIs by the plant and, in the case of some conventional formulations, they are used in association with the formulation in the spray mixture, ensuring agronomical effectiveness of the AI. Thus, OD formulations can be deemed “adjuvanted” formulations and do not require additional associated adjuvants to be applied in the field.

Though OD formulation is called as adjuvated formulation it still requires various adjuvans along with formulation excipients. OD formulation presents several challenges in the process of manufacturing and developing stable and effective formulation with choice of proper formulation excipient or adjuvants. To obtain a good and stable formulation over time, optimal formulation additives are required in addition to optimum processes. There were several development and research done in the filed of formulation development of Oil Dispersion (OD) formulation. Dispersion and activation of active ingredients is the key to the stability of the formulation over time. Solvents or carrier used as a petroleum based or the aromatic solvent we replaced by the solvents in the form of vegetable oils. Vegetable oils application as a formulation excipients in OD formulation further have their own challenges for stable formulation due to stability issue associated with vegetable oil used and corresponding active ingredient. Although various research has been done in formulation development it has got many draw backs as having high dose of active ingredients and thereby maximizing the pesticidal load into the environment. Many OD formulations has less thermal and chemical stability over a broad range of conditions; increases the toxicity hazards to the applicators and thereby decreasing the safety of applicators at the time of handling and spraying the pesticides. Further some OD formulation with less suitable formulation excipients may lead to have less leaf penetration of spray droplets, and increases evaporation loss and minimize the absorption of active ingredients.

Therefore there is further need and scope in the formulation development of the OD formulation comprising one or more active ingredients with better stability profile and increases the synergistic effect of the active ingredients, reduces the toxicity with less introduction of toxic material in environment, which may reduced the dose of the pesticides and eventually produce less chemicals in environment, with better safety profile for contact pesticides.

US20160088835A1N relates to an agrochemical oil dispersion formulations include at least one active ingredient Suspended in oil phase, dispersants, a clay-based rheological additive, a cellulose derived rheological additive and emulsifying agents, wherein they can further include at least one active ingredient solubilized in the oil phase. These agrochemical oil dispersion formulations can be used in spray mixtures for controlling pests in agriculture. The novel agrochemical oil dispersion formulations are obtained by a process which includes dispersing at least one active ingredient in the oil phase with dispersants and a clay based rheological additive, followed by milling the dispersed mixture and a final mixing step where cellulose- and clay based rheological additives are added in addition to emulsifying agents, wherein at least one active ingredient can also be added by solubilization.

WO2016142518A1 relates to a non-aqueous, emulsifiable and pourable concentrate formulation comprising at least 20% by weight of at least one non-ionic surfactant chosen from polyethylene glycol esters of fatty acids surfactants, relative to the total weight of the concentrate formulation; a liquid medium wholly or partly formed from at least one non esterified vegetable oil or mixtures thereof; at least one phyllosilicate, said phyllosilicate being present in a content of less than or equal to 5% by weight relative to the total weight of the concentrate formulation; and at least one activator of said phyllosilicate. The invention also relates to the use of such a concentrate formulation for preparing a liquid aqueous emulsion, a suspoemulsions or an agricultural oil dispersion.

US20120208700A1 relates to a preparation of stable oil dispersion formulation with use of the rheology modifiers. This disclosure concerns the use of dibenzylidene sorbitol (DBS) or chemical derivatives of DBS as rheology modifiers useful in preparing stable oil dispersion (OD) compositions of agrochemical products.

EP2563115B1 relates to an invention concerns agrochemical oil dispersions stabilized against particle sedimentation by the use of a combination of a clay or silica type rheology modifier and a polymer or oligomer capable of hydrogen bonding. Agricultural formulation products must be physically and chemically stable for a specified period of time in order to have commercial utility.

EP2928298B1 relates to an oil-based pesticidal suspension comprising flonicamid or its salt as an active ingredient, containing an organic silicone type surfactant. The present patent further relates to a method of suppressing foaming which occurs when an oil-based pesticidal suspension comprising flonicamid or its salt, an organic silicone type surfactant and at least one oil based diluting agent selected from the group consisting of a vegetable oil and its alkylated oil, is diluted with water, by the oil-based diluting agent, and use of the oil-based diluting agent to suppress foaming which occurs when an oil-based pesticidal suspension comprising flonicamid or its salt, an organic silicone type surfactant and at least one oil-based diluting agent selected from the group consisting of a vegetable oil or its alkylated oil, is diluted with water.

There is however a need for improvement of OD formulations. Many a times it has been found that single or combination of active ingredients requires a high loading dose for the better results in the agriculture. Further this will create a higher loading of the pesticides in the environment. Further many of the OD formulation recipe is prone to lose stability when exposed to the higher temperature. In addition there are higher chances of formulation applied gets evaporated resulting in the loss of the active ingredients before penetration.

Therefore there is a need to formulate the novel OD formulation which increases the synergistic activities between active ingredients by using the appropriate formulation excipients; enhance the duration of control of insect-pests and mites, fungal and bacterial diseases and weed control; reduce the doses of active ingredients and thereby minimizing the pesticidal load into the environment; has thermal and chemical stability over a broad range of conditions; reduces the toxicity hazards to the applicators, i.e. improves the safety of applicators at the time of handling and spraying the pesticides; and improves leaf penetration of spray droplets, retard evaporation loss and enhance the absorption of active ingredients.

Therefore, an object of the present invention is to provide improved synergistic Oil Dispersion (OD) formulation for the agricultural purpose comprising at least one active ingredients. Active ingredients for the present invention are selected from category of pesticides and plant health additives. Pesticides can be classified according to the pests they control, and among the most common pesticides found in the market are herbicides, insecticides, fungicides and acaricides.

Further object of the present invention is to provide suitable formulation excipients for the present Oil Dispersion formulation in order to produce stable and synergistic formulation.

Another object of the present invention is to provide a method and a composition for the OD formulation.

Embodiment of the present invention can ameliorate one or more of the above mentioned problems.

Inventors of the present invention have surprisingly found that the novel synergistic OD formulation with at least one active ingredients can provide solution to the above mentioned problems.

### SUMMARY OF INVENTION

Therefore an aspect of the present invention provides a synergistic agrochemical Oil Dispersion (OD) formulation comprising at least one active ingredients suspended in oil phase.

Another aspect of the present invention to provide synergistic agrochemical Oil Dispersion (OD) formulation comprising Super Wetting-spreading-penetrating agent—Polyalkyleneoxide modified Heptamethyl trisiloxane (Modified trisiloxane).

Further aspect of the present invention to provide synergistic agrochemical Oil Dispersion (OD) formulation comprising carrier or solvent selected from Pongamia/karanja/karanj oil; or palm oil; or Pongamia oil and palm oil; or Pongamia oil and jojoba oil; or palm oil and jojoba oil; or Pongamia oil and vegetable oil; or palm oil and vegetable oil; or Pongamia oil and palm oil and vegetable oil; or solvent; or both.

Further aspect of the present invention to provide synergistic agrochemical Oil Dispersion (OD) formulation comprising formulation excipients from the category of emulsifying agent, dispersing agent, stabilizers, antifoaming agent, preservative, anti-freezing agent and buffering agents.

Another aspect of the present synergistic agrochemical Oil Dispersion (OD) formulation, active ingredient is compound selected from group of insecticide, fungicide, herbicide or plant health additives or combination thereof.

Another aspect of the present synergistic agrochemical Oil Dispersion (OD) formulation, active ingredients are selected from at least one insecticide or combination thereof or in combination with fungicide or in combination with herbicide or with plant health additives or combination thereof; or at least one fungicide or combination of thereof or in combination with insecticide or in combination with herbicide or with plant health additives or combination thereof, or at least one herbicide or in combination with fungicide or in combination with insecticide or with plant health additives or combination thereof.

Further aspect of the present invention to provide novel agrochemical Oil Dispersion (OD) formulation comprising at least one active ingredient suspended in oil phase shows synergistic activity and stability over wide range of the conditions.

In a further embodiment of the present invention, a fungicide may be selected from Nucleic acid synthesis inhibitors; Cytoskeleton and motor proteins/cell division Inhibitors; Respiration inhibitors; Amino acids and protein synthesis inhibitors; Signal transduction inhibitors; Lipid or transport and membrane synthesis inhibitors; Sterol biosynthesis Inhibitors; Cell wall biosynthesis Inhibitors; Melanin synthesis in cell wall Inhibitors; Plant defence inducers; Unknown mode of action; Not classified (N); Chemicals with multisite activities (M)-multisite contact activities; In a further embodiment of the present invention, a herbicide may be selected from Inhibitor of Acetyl CoA Carboxylase (ACCase); Inhibitor of Acetolactate Synthase (ALS) or Acetohydroxy Acid Synthase (AHAS); Inhibitor of microtubule assembly; Synthetic Auxin; Inhibitor of photosynthesis at photosystem II site A; Inhibitor of photosynthesis at photosystem II site B; Inhibitor of photosynthesis at photosystem II site A; different behavior from group 5; Inhibitor of lipid synthesis; not ACCase inhibition; Inhibitor of 5-enolypyruvyl-shikimate-3-phosphate synthase (EPSPS): Glycine; Inhibitor of glutamine synthetase: Phosphonic acid; Inhibitor of phytoene desaturase (PDS); Inhibitor of 1-deoxy-D-xyulose 5-phosphate synthatase (DOXP synthase); Inhibitor of protoporphyrinogen oxidase (Protox, PPO); Mitosis Inhibitor; Inhibitor of 7,8-dihydro-preroate synthetase (DHP); Inhibitor of indoleacetic acid transport; Inhibitor of cell wall synthesis site A; Inhibitor of cell wall synthesis site B; Inhibitor of cell wall synthesis site C; Inhibition of cellulose synthesis; Photosystem I electron diverter; Membrane disruptor (uncouplers); Inhibitor of Hydroxyphenyl Pyruvate Dioxygenase (4-HPPD); Tyrosine Aminotransferase; Inhibition of dihydroorotate dehydrogenase (DHODH); HTS (homogentisate solanesyltransferase)—a downstream enzyme of HPPD; Very Long Chain Fatty Acid Inhibitors; Inhibition of lycopene cyclase; Inhibition of Solanesyl Diphosphate Synthase (SDS); Inhibition of serine-threonine protein phosphatase; Unknown mode of action.

In a further embodiment of the present invention, an insecticide may be selected from Carbamates; Organophosphates; Phenylpyrazole; Pyrethroids; Nicotinic insecticides; Spinosyns; Mectins; Juvenile hormone mimics; Chordotonal organs modulators; Mite growth inhibitors; Microbial disruptors of insect midgut membrane; Inhibitors of mitochondrial ATP synthase; Uncouplers of oxidative phosphorylation; Chitin biosynthesis inhibitors; Inhibitors of the chitin biosynthesis type 1; Moulting disruptors; Ecdyson receptor agonists; Octopamin receptor agonists; METI (mitochondrial electron transport inhibitors; Voltage-dependent sodium channel blockers; Inhibitors of the lipid synthesis, inhibitors of acetyl CoA carboxylase; Diamides; Metadiamides; Isoxazolines; Baculoviruses; compounds of unknown or uncertain mode of action.

In a further embodiment of the present invention, plant health additives are selected from bio-stimulants, plant growth regulators, microbial agents and micronutrients or mixture thereof.

The novel agrochemical oil dispersion formulations described herein are obtained by a process comprising a step of preparing the liquid premix by charging the oil or solvent or both followed by adding super wetting-spreading-penetrating agent. The further step is adding the active ingredients into the premixed through milling for the proper size distribution. Further adding the thickening agent followed by stirring the slurry get prepared by milling process to prepare the final formulation. These agrochemical oil dispersion formulations can be used in spray mixtures in agriculture.

### DETAIL DESCRIPTION OF THE INVENTION

Formulation technology in the field of an agriculture is now seen as an “enabling technology” which can provide safe and effective products which are convenient to use. It can also modify the toxicity of active ingredients and improve their ability to target a specific pest. At a time when the discovery of new agrochemical compounds is more difficult and certainly a high risk and expensive operation, formulation technology can extent the useful patent life of an active ingredient. It can also provide a competitive edge by improving product quality of existing formulations, or by introducing a new formulation of an active ingredient.

OD formulations are non-aqueous dispersion intended for dilution into water before use, and represent the most complex of the non-aqueous suspension formulations. Oil dispersion (OD) formulations consist of a suspension of a solid technical in oil. The oil also serve as a carrier for additives. The oil dispersion is usually dispersed in water prior to spraying.

An Oil Dispersion is a non-aqueous suspension concentrate. It combines a very good biological efficacy with an environmental friendly formulation. The active ingredient is dispersed in oils or methylated crop oils.

Oil Dispersion formulation comprises with some features as it comprises no aromatic solvent; is non-aqueous formulation; non-flammable and low volatility; higher efficiency.

Oil Dispersion (OD) have several advantages over standard formulations. Emulsifiable Concentrates (ECs) formulations are under a strong regulatory pressure to replace toxic and flammable solvents with a less toxic and non-flammable solutions. ODs meets these needs: the oil content gives a favourable eco-toxicological profile guarantying a very high biological efficacy. Further OD formulations are non-toxic and non-flammable formulations. Over the EC formulation OD formulation is having very high biological efficacy.

Suspension concentrates (SC) formulations are very safe formulations but the aqueous media is normally not ideal to boost the pesticide's biological efficacy. As an agriculture growers standard practice, tank mix adjuvants are added to guarantee a higher performance. OD, with its oil content, guarantees the best biological results. For water sensitive active ingredients, OD represents the sole technical solution to liquid formulation. OD formulation over SC formulation is very safe formulation along with high biological performance. Further OD formulation is ideal for all the active ingredients not stable in water.

Water dispersible granules (WDG) formulations are very safe but quite expensive. Optimal biological efficacy requires adjuvants. OD, with its oil content and better particle size distribution, combines high efficacy with better cost. OD formulation over WDG has economic significance as having better efficacy at a lower cost.

OD formulation presents several challenges in preparation and manufacturing phase. To obtain a good and stable formulation over time, optimal formulation additives are required in addition to optimum processes. Particular attention must be given to choice of all the formulation excipients

Its dispersion and activation are key to the stability of the formulation over time.

Some important requirement of the formulation excipients are perfectly dispersible in oil, no phase separation, easy milling, with no agglomeration, excellent oil emulsification, stable dilution, good coverage and penetration, even distribution through the whole formulation, provide the right yield value of active ingredients.

Therefore an aspect of the present invention provides a novel synergistic agrochemical Oil Dispersion (OD) formulation comprising at least one active ingredient suspended in an oil phase along with formulation excipients and the present OD formulation shows synergistic effect.

Further aspect of the present invention to provide novel agrochemical Oil Dispersion (OD) formulation comprising at least one active ingredient suspended in oil phase shows synergistic activity and stability over wide range of the conditions.

In an especially preferred embodiment of the invention, the yield of the treated plant is increased.

In another preferred embodiment of the invention, the yield of the plants treated according to the method of the invention, is increased synergistically.

The term “synergistic”, as used herein, refers the combined action of two or more active agents blended together and administered conjointly that is greater than the sum of their individual effects.

In an embodiment of the present synergistic agrochemical Oil Dispersion (OD) formulation, active ingredient is compound selected from group of insecticide, fungicide, herbicide or plant health additives or combination thereof.

Further aspect of the present invention to provide synergistic agrochemical Oil Dispersion (OD) formulation comprising formulation excipients from the category of emulsifying agent, dispersing agent, stabilizers, antifoaming agent, preservative, anti-freezing agent and buffering agents.

Another aspect of the present synergistic agrochemical Oil Dispersion (OD) formulation, active ingredient are selected from at least one insecticide or combination thereof or in combination with fungicide or in combination with herbicide or with plant health additives or combination thereof; or at least one fungicide or combination of thereof or in combination with insecticide or in combination with herbicide or with plant health additives or combination thereof, or at least one herbicide or in combination with fungicide or in combination with insecticide or with plant health additives or combination thereof.

In an embodiment of the present invention, an insecticide may be selected from Carbamates; Organophosphates; Phenylpyrazole; Pyrethroids; Nicotinic insecticides; Spinosyns; Mectins; Juvenile hormone mimics; Chordotonal organs modulators; Mite growth inhibitors; Microbial disruptors of insect midgut membrane; Inhibitors of mitochondrial ATP synthase; Uncouplers of oxidative phosphorylation; Chitin biosynthesis inhibitors; Inhibitors of the chitin biosynthesis type 1; Moulting disruptors; Ecdyson receptor agonists; Octopamin receptor agonists; METI (mitochondrial electron transport inhibitors; Voltage-dependent sodium channel blockers; Inhibitors of the lipid synthesis, inhibitors of acetyl CoA carboxylase; Diamides; Metadiamides; Isoxazolines; Baculoviruses; compounds of unknown or uncertain mode of action.

In a further embodiment of the present invention, an insecticide may be selected from: Carbamates: —carbaryl, carbofuran, carbosulfan, methomyl, oxamyl, pirimicarb, thiodicarb; Organophosphates: —acephate, cadusafos, chlorpyrifos, chlorpyrifos-methyl, demeton-S-methyl, dimethoate, ethion, fenamiphos, fenitrothion, fenthion, fosthiazate, methamidophos, monocrotophos, oxydemeton-methyl, parathion, parathion-methyl, phenthoate, phorate, phosalone, phosphamidon, profenofos, quinalphos, triazophos; Phenylpyrazole: —ethiprole, fipronil, flufiprole, nicofluprole, pyrafluprole, or pyriprole; Pyrethroids: —bifenthrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, fenpropathrin, fenvalerate, tau-fluvalinate, permethrin, phenothrin, prallethrin, profluthrin, pyrethrin (py rethrum); Nicotinic insecticides: —acetamiprid, clothianidin, dinotefuran, imidacloprid, nitenpyram, thiacloprid, thiamethoxam, flupyrimin, cycloxaprid, paichongding, guadipyr, cycloxylidin, sulfoxaflor, flupyradifurone, triflumezopyrim, dichloromezotiaz; Spinosyns: —spinosad, spinetoram; Mectins: —abamectin, emamectin benzoate, ivermectin, lepimectin, milbemectin; Juvenile hormone mimics: —hydroprene, kinoprene, methoprene, fenoxycarb, pyriproxyfen; Chordotonal organs modulators-pymetrozine, pyrifluquinazon, afidopyropen, flonicamid; Mite growth inhibitors: —clofentezine, hexythiazox, diflovidazin or etoxazole; Microbial disruptors of insect midgut membrane: —Bacillus thuringiensis and insecticidal proteins; Inhibitors of mitochondrial ATP synthase: —diafenthiuron, azocyclotin, cyhexatin, fenbutatin oxide, propargite, or tetradifon; Uncouplers of oxidative phosphorylation: —chlorfenapyr, DNOC, or sulfluramid; Nereis toxin: —bensultap, monosultap, cartap hydrochloride, thiocyclam, thiocyclam hydrogen oxalate, thiocyclam hydrochloride, thiosultap sodium; Chitin biosynthesis inhibitors: —benzoylureas-bistrifluron, chlorfluazuron, diflubenzuron, flucycloxuron, flufenoxuron, hexaflumuron, lufenuron, novaluron, noviflumuron, teflubenzuron, triflumuron; Inhibitors of the chitin biosynthesis type 1: —buprofezin; Moulting disruptors: —cyromazine; Ecdyson receptor agonists: —diacylhydrazines-methoxyfenozide, tebufenozide, halofenozide, fufenozide or chromafenozide; Octopamin receptor agonists: —amitraz; METI (mitochondrial electron transport inhibitors: —fenazaquin, fenpyroximate, pyrimidifen, pyridaben, tebufenpyrad, tolfenpyrad, flufenerim, rotenone, cyenopyrafen, cyflumetofen, pyflubumidemm, hydramethylnon, acequinocyl, flometoquin, fluacrypyrim, pyriminostrobin or bifenazate; Voltage-dependent sodium channel blockers: —oxadiazines-indoxacarb, semicarbazones-metaflumizone; Inhibitors of the lipid synthesis, inhibitors of acetyl CoA carboxylase: —Tetronic and tetramic acid derivatives-spirodiclofen, spiromesifen, spirotetramat, spidoxamat or spiropidion; Diamides: —chlorantraniliprole, cyantraniliprole, cyclaniliprole, cyhalodiamide, cyproflanilide, flubendiamide, tetraniliprole, tetrachlorantraniliprole, tyclopyrazoflor; Metadiamides-broflanilide; Isoxazolines- fluxametamide, isocycloseram; Baculoviruses: —granuloviruses and nucleopolyhedrosis viruses; Compounds of unknown or uncertain mode of action: —azadirechtin, benzpyrimoxan (insect growth regulators), pyridalyl, oxazosulfyl, dimpropyridaz (carboxamide insecticide), flometoquin, fluhexafon, cyetpyrafen, flupentiofenox, acyonapyr, cyclobutrifluram, fluazaindolizine, tioxazafen.

In an embodiment of the present invention, a fungicide may be selected from Nucleic acid synthesis inhibitors; Cytoskeleton and motor proteins/cell division Inhibitors; Respiration inhibitors; Amino acids and protein synthesis inhibitors; Signal transduction inhibitors; Lipid or transport and membrane synthesis inhibitors; Sterol biosynthesis Inhibitors; Cell wall biosynthesis Inhibitors; Melanin synthesis in cell wall Inhibitors; Plant defence inducers; Unknow mode of action; Not classified (N); Chemicals with multisite activities (M)-multisite contact activities; In a further embodiment of the present invention, a fungicide may be selected from:
a) Nucleic acid synthesis inhibitors: —PhenylAmides group (A1)-Acylalanines-benalaxyl, benalaxyl-M (=kiralaxyl), furalaxyl, metalasxyl, metalaxyl-M (=mefenoxam)), butyrolactones (ofurace), oxazolidinones (oxadixyl), hydroxy-(2-amino-) pyrimidines; A2. bupirimate, dimethirimol, ethirimol, heteroaromatics; (A3)-isothiazolones-octhilinone, isoxazoles-hymexazole; carboxylic acids (A4)-oxolinic acid; Other-5-fluorocytosine, 5-fluoro-2-(p-tolylmethoxy)pyrimidin-4-amine, 5-fluoro-2-(4-fluorophenylmethoxy) pyrimidin-4-amine;
b) Cytoskeleton and motor proteins/cell division Inhibitors: —benzimidazoles (B1)-benomyl, carbendazim, fuberidazole, thiabendazole; thiophanates (B1)-thiophanate, thiophanate-methyl; N-phenyl carbamates (B2)-diethofencarb; toluamides (B3)-zoxamide; ethylamino-thiazole-carboxamide (B3)-ethaboxam; phenylureas (B4)-pencycuron; pyridinylmethyl benzamides (B5)-fluopicolide, flufenoxadiazam, fluopimomide; aminocyanoacrylates (B6)-phenamacril; benzophenone (B6)-metrafenone; benzoylpyridine (B6)-pyriofenone.
c) Respiration inhibitors: —Pyrimidinamines (C1)-diflumetorim; pyrazole-5-carboxamide (C1)-tolfenpyrad; quinazoline (C1)-fenazaquin; SDHI (Succinate dehydrogenase inhibitors) (C2)-phenyl-benzamides (C2)-benodanil, flutolanil, mepronil; phenyl-oxo-ethyl thiophene amid (C2)-isofetamid; pyridinyl-ethyl-benzamides (C2)-fluopyram; furan-carboxamides (C2)-fenfuran; oxathin-carboxamides (C2)-carboxin, oxycarboxin, thiazole-carboxamides (C2)-thifluzamide; pyrazole-4-carboxamides (C2)-benzovindiflupyr, bixafen, fluindapyr, fluxapyroxad, furametpyr, isopyrazam, penflufen, penthiopyrad, sedaxane, flubeneteram, pyrapropoyne, inpyrfluxam, isoflucypram, pydiflumetofen; pyridine carboxamides (C2)-boscalid, pyraziflumid; QoI-fungicides (Quinone outside Inhibitors) (C3)-benzyl carbamates-pyribencarb; dihydro dioxazines-fluoxastrobin; imidazolinones-fenamidone; methoxy acetamide; mandestrobin; methoxy acrylates-azoxystrobin, coumoxystrobin, enoxastrobin, flufenoxystrobin, picoxystrobin, pyraoxystrobin; methoxy carbamates-pyraclostrobin, pyrametostrobin, triclopyricarb; oxazolidine diones-famoxadone; oximino acetamides-dimoxystrobin, fenamistrobin, metominostrobin, orysastrobin; oximino acetates-kresoxim methyl, trifloxystrobin; QiI-fungicides (Quinone inside Inhibitors) (C4)-cyano imidazole-cyazofamid; sulfamoyl triazole-amisulbrom; picolinamides-fenpicoxamid, florylpicoxamid, metarylpicoxamid; tetrazolinones-metyltetraprole; uncouplers of oxidative phosphorylation (C5)-dinitophenyl crotonates (C5)-binapacryl, meptyldinocap, dinocap, 2,6-dinitro anilines (C5)-fluazinam, inhibitors of oxidative phosphorylation, ATP synthase (C6)-tri phenyl tin compounds (C6)-fentin acetate, fentin chloride, fentin hydroxide, ATP transport (C7)-thiophene (C7)-silthiofam, Quinone outside Inhibitors, stigmatellin binding type (QoSI-C8) triazolo pyrimidylamine (C8)-ametoctradin;
d) d) Amino acids and protein synthesis inhibitors—anilino-pyrimidines (D1)-cyprodinil, mepanipyrim, pyrimethanil, enopyranuronic acid antibiotic (D2)-blasticidin-S, hexopyranosyl antibiotic (D3)-kasugamycin, glucopyranosyl antibiotic (D4)-streptomycin, tetracycline antibiotic (D5)-oxytetracycline;
e) e) Signal transduction inhibitors: —aryloxyquinoline (E1)-quinoxyfen, quinazolinone (E1)-proquinazid, phenylpyrroles (E2)-fenpiclonil, fludioxonil, dicarboximides (E3)-chlozolinate, dimethachlone, iprodione, procymidone, vinclozolin;
f) f) Lipid or transport and membrane synthesis inhibitors: —dithiolanes (F2)-isoprothiolane, phosphorthiolates (F2)-edifenphos, iprobenfos (IBP), pyrazophos, aromatic hydrocarbons (F3)-biphenyl, chloroneb, dicloran, quintozene, tecnazene, tolcofos methyl, etridiazole, carbamates (F4)-iodocarb, propamocarb, prothiocarb, terpene hydrocarbons (F7)-extract from Melaleuca arternifolia (tea tree), plant oils (mixtures); eugenol, geraniol, thymol, amphoteric macrolide antifungal (F8)-natamycin (pimaricin), piperidinyl thiazole isoxazolines (F9)-oxathiapipronil, fluoxapipronil, Fluoxapiprolin-s;
g) g) Sterol biosynthesis Inhibitors: —imidazoles (G1)-imazalil, imidazoles (G1)-oxpoconazole, pefurazoate, procloraz, triflumizole, piperazines-triforine, pyridines-pyrifenox, pyrisoxazole, pyrimidines-fenarimo, naurimol, triazoles-azaconazole, bitertanol, bromuconazole, cyproconazole, difenoconazole, diniconazole, epoxiconazole, etaconazole, fenbuconazole, fluquinconazole, flusilazole, frutriafol, hexaconazole, imibenconazole, ipconazole, mefentrifluconazole, metconazole, myclobutanil, penconazole, propiconazole, prothioconazole, simconazole, tebuconazole, tetraconazole, tiradimefon, tiradimenol, triticonazole, fluoxytioconazole, morpholines (G2)-aldimoprh, dedomorph, tridemorph, fenpropimorph, piperidines (G2)-fenpropidin, piperalin, spiroketal amines (G2)-spiroxamine, amino pyrazolinone (G3)-fenpyrazamine, hydroxyanilides (G3)-fenhexamid, allaylamines (G4)-naftifine, terbinafine, pyributicarb;
h) h) Cell wall biosynthesis Inhibitors: —peptidpyl pyrimidine (H4)-polyoxin, cinnamic acid amides (H5)-dimethomorph, flumorph, pyrimorph, mandelic acid amides (H5)-mandipropamid, valinamide carbamates (H5)-benthiavalicard, iprovalicarb, alifenalate;
i) i) Melanin synthesis in cell wall Inhibitors: —isobenzo furanone (I1)-fthalide, pyrrolo quinolinone-pyroquilon, triazolobenzothiazole-tricyclazole, carboxamide (I2)-diclycymet, cyclopropane carboxamide (I2)-carpropamid, propionamide (I2)-fenoxanil, trifluoroethyl carbamate (I3)-tolprocarb,
j) p) Plant defence inducers: —benzothiadiazole (P1)-acibenzolar-S-methyl, probenazole, thiadiazole (P3)-tiadinil, isotianil, polysaccharides (P4)-laminarin, complex mixture thanol extract (P5)-extract from Reynoutria sachalinensis (giant knowweed), bacterial Bacillus (P6)-Bacillus mycoides isolate J, cell awall of Saccharomyces erevisiae strain LAS 117, phosphonates (P7)-fosetyl-AL, phosphoric acid and salts,
k) u) Unknow mode of action: —cyanoacetamide oxime-cymoxanil, phthalamic acid-teclofthalam, benzotirazines-triazoxide, benzene-sulfonamides-fluslfamide, pyridazinones-diclomezine, phenyl acetamide-cyflufenamid, guanindines-dodine, cyano methylene thiazolidines-flutianil, pyrimidinone hydrazones-ferimzone, flumetylsulforim, 4-quinolyl acetates-tebufloquin, tetrazolyloximes-picarbutrazox, glucopyranosyl antibiotics-validamycin,
1) n) Not classified (N)-mineral oils, inorganic oils, organic oils, potassium bicarbonates, materials of biological origin,
m) m) Chemicals with multisite activities (M)-multisite contact activities—inorganic-copper (copper hydroxide, copper oxychloride, copper (II) sulphate, Bordeaux mixture, copper salicylate, cuprous oxide), sulphur, dithiocarbamates and relatives-ferbam, mancozeb, maneb, metiram, propineb, thiram, zinc thiazole, zineb, ziram, phthalimides-captan, captafol, folpet, chloronitriles (phthalonitriles)-chlorothalonil, sulfamides-dichlofluanid, tolylfluanid, bis guanidines-guazatine, iminoctadine, triazines-anilazine, quinones (anthraquinones)-dithianon, quinoxalines-chinomethionat/quinomethionate, maleimide-fluoroimide, thiocarbamate-methasulfocarb,
n) (bm) Biologicals with multiple modes of action (BM)—polypeptide (lectin)-extract from the cotyledons of lupine plantlets (“BLAD”), Plant extract-Phenols, Sesquiterpenes, Triterpenoids, Coumarins, microbial (living microbes or extract metabilites-Trichoderma atroviride strain SC1, Trichoderma atroviride strain I-1237, Trichoderma atroviride strain LU132, Trichoderma asperellum strain T34, Gliocladium catenulatum strain J1446, Clonostachys rosea strain CR-7, Bacillus amyloliquefaciens strain QST713, strain FZB24, strain MBI600, strain D747, strain F727, Bacillus subtilis strain AFS032321, Pseudomonas chlororaphis strain AFS009, Streptomyces griseovirides strain K61, Streptomyces lydicus strain WYEC108
o) Others: —Ipflufenoquin-quinoline fungicide, Pyridachlometyl-pyridazine fungicide, quinofumelin, dichlobentiazox, aminopyrifen, dipymetitrone, seboctylamine (bactericide), chloroinconazide (virucide).

In an embodiment of the present invention, a herbicide may be selected from Inhibitor of Acetyl CoA Carboxylase (ACCase); Inhibitor of Acetolactate Synthase (ALS) or Acetohydroxy Acid Synthase (AHAS); Inhibitor of microtubule assembly; Synthetic Auxin; Inhibitor of photosynthesis at photosystem II site A; Inhibitor of photosynthesis at photosystem II site B; Inhibitor of photosynthesis at photosystem II site A; different behavior from group 5; Inhibitor of lipid synthesis; not ACCase inhibition; Inhibitor of 5-enolypyruvyl-shikimate-3-phosphate synthase (EPSPS): Glycine; Inhibitor of glutamine synthetase: Phosphonic acid; Inhibitor of phytoene desaturase (PDS); Inhibitor of 1-deoxy-D-xyulose 5-phosphate synthatase (DOXP synthase); Inhibitor of protoporphyrinogen oxidase (Protox, PPO); Mitosis Inhibitor; Inhibitor of 7,8-dihydro-preroate synthetase (DHP); Inhibitor of indoleacetic acid transport; Inhibitor of cell wall synthesis site A; Inhibitor of cell wall synthesis site B; Inhibitor of cell wall synthesis site C; Inhibition of cellulose synthesis; Photosystem I electron diverter; Membrane disruptor (uncouplers); Inhibitor of Hydroxyphenyl Pyruvate Dioxygenase (4-HPPD); Tyrosine Aminotransferase; Inhibition of dihydroorotate dehydrogenase (DHODH); HTS (homogentisate solanesyltransferase)—a downstream enzyme of HPPD; Very Long Chain Fatty Acid Inhibitors; Inhibition of lycopene cyclase; Inhibition of Solanesyl Diphosphate Synthase (SDS); Inhibition of serine-threonine protein phosphatase; Unknown mode of action.

In a further embodiment of the present invention, an herbicide may be selected from: nhibitor of Acetyl CoA Carboxylase (ACCase): Aryloxyphenoxy-propionate (‘FOPs’): clodinafop-propargyl, cyhalofop-butyl, diclofop, fenoxaprop-P-ethyl, fluazifop-P-butyl, haloxyfop, metamifop, propaquizafop, quizalofop-P-ethyl; Cyclohexanedione (‘DIMs’): alloxydim, butroxydim, clethodim, cycloxydim, sethoxydim, tralkoxydim, tepraloxydim; Phenylpyrazoline (‘DEN’): pinoxaden.

Inhibitor of Acetolactate Synthase (ALS) or Acetohydroxy Acid Synthase (AHAS): Sulfonylurea: amidosulfuron, azimsulfuron, bensulfuron methyl, chlorimuron ethyl, chlorsulfuron, cinosulfuron, cloransulfuron methyl, cyclosulfamuron, ethametsulfuron methyl, ethoxysulfuron, flazasulfuron, flucetosulfuron, flupyrsulfuron methyl sodium, foramsulfuron, halosulfuron methyl, imazosulfuron, iodosulfuron, mesosulfuron, metazosulfuron, metsulfuron methyl, nicosufulfuron, primisulfuron methyl, prosulfuron, pyrazosulfuron ethyl, rimsulfuron, rimsulfuron, sulfometuron methyl, sulfosulfuron, thifensulfuron-methyl, triasulfuron, tribenuron methyl, trifloxysulfuron, triflusulfuron methyl; Pyrimidinyl benzoate: bispyribac-sodium, pyribenzoxim, pyrithiobac sodium; Triazolopyrimidine: cloransulam-methyl, diclosulam, florasulam, flumetsulam, penoxsulam, pyroxsulam; Triazolinone-flucarbazone-sodium, propoxycarbazone-sodium, thiencarba zone-methyl; Imidazolinone: imazamethabenz methyl, Imazamox, imazapic, imazapyr, imazaquin, imazethapyr; Sulfonanilides: triafamone, pyrimisulfan; Inhibitor of microtubule assembly: Dinitroaniline: benefin, trifluralin, ethafluralin, oryzalin, pendimethalin, prodiamine; Benzoic acid: DCPA; Pyridine: dithiopyr, thiazopyr; Benzamide: pronamide.

Synthetic Auxin: Phenoxy carboxylic acid: 2,4-D, 2,4-DB, dichloroprop, MCPA, MCPB, mecoprop; Pyrimidine carboxylic acid: aminocyclopyrachlor; Pyridine carboxylic acid: aminopyralid, clopyralid, florpyrauxifen benzyl, fluroxypyr, picloram, triclopyr; Benzoic acid: dicamba; Quinoline carboxylic acid: quinclorac; Other: halauxifen methyl.

Inhibitor of photosynthesis at photosystem II site A: Phenyl carbamate: desmedipham, phenmedipham; Pyridazinone: pyrazon; Triazine: ametryn, atrazine, cyanazine, desmetryn, prometon, prometryn, propazine, simazine, simetryn, terbumeton, terbuthylazine, trietazine; Triazinone: hexazinone, metamitron, metribuzin; Triazolinone: amicarbazone; Urea: metoxuron; Uracil: bromacil, terbacil.

Inhibitor of photosynthesis at photosystem II site B: Benzothiadiazinone: bentazone; Nitrile: bromoxynil, ioxynil; Phenyl-pyridazine: pyridate.

Inhibitor of photosynthesis at photosystem II site A; different behavior from group 5: Amide: propanil; Urea: chlorotoluron, dimefuron, diuron, fluometuron, isoproturon, linuron, methibenzuron, monolinuron, siduron, tebuthiuron.

Inhibitor of lipid synthesis; not ACCase inhibition: Benzofuran: ethofumesate; Phosphorodithioate: bensulie; Thiocarbamate: butylate, cycloate, EPTC, esprocarb, molinate, pebulate, prosulfocarb, thiobencarb, triallate, vernolate.

Inhibitor of 5-enolypyruvyl-shikimate-3-phosphate synthase (EPSPS): Glycine: Glyphosate.

Inhibitor of glutamine synthetase: Phosphonic acid: glufosinate.

Inhibitor of phytoene desaturase (PDS): Pyridinecarboxamide: diflufenican, picolinafen; Pyridazinone: norflurazon; Others: beflubutamid, fluridone, flurochloridone, flurtamone.

Inhibitor of 1-deoxy-D-xyulose 5-phosphate synthatase (DOXP synthase): Isoxazolidinone: clomazone.

Inhibitor of protoporphyrinogen oxidase (Protox, PPO): Dipheylether: aclifluorfen, bifenox, fluoroglycofen, fomesafen, lactofen, oxyfluorfen; Triazolinone: azafenidin, carfentrazone-ethyl, flufenpyr-ethyl, sulfentra-zone; Pyrimidinedione: butafenacil, saflufenacil; N-phenylphthalimide: flumiclorac, flumioxazin; N-Phenyl-imide: trifludimoxazin; Thiadiazole: fluthiacet-methyl; Oxadiazole: oxadiargyl, oxadiazon; Phenylpyrazole: pyraflufen-ethyl, Other: pyraclonil; Uracil: tiafenacil; Pyrazole: cyclopyranil.

Mitosis Inhibitor: Chloroacetamide: acetochlor, alachlor, butachlor, dimethenamid, metazachlor, pretilachlor, propachlor, S-metolachlor, thenylchlor; Tetrazolinone: fentrazamide; Oxyacetamide: flufenacet, mefenacet; Acetamide: napropamide; other: anilofos; Carbamate: carbetamide.

Inhibitor of 7,8-dihydro-preroate synthetase (DHP): Carbamate: asulam.

Inhibitor of indoleacetic acid transport: Phthalamate semicarbazone: diflufenzopyr, naptalam.

Inhibitor of cell wall synthesis site A: Nitrile: dichlobenil. Inhibitor of cell wall synthesis site B: Benzamide: isoxaben. Inhibitor of cell wall synthesis site C: Alkylazines: indaziflam, triaziflam.

Inhibition of cellulose synthesis: Triazolocarboxamide: flupoxam; Nitriles: dichlobenil, chlorthiamide.

Photosystem I electron diverter: Pyridiniums: cyperquat, diquat, morfamquat, paraquat.

Membrane disruptor (uncouplers): Dinitrophenol: dinoterb.

Inhibitor of Hydroxyphenyl Pyruvate Dioxygenase (4-HPPD): Pyrazole: bipyrazone, cypyrafluone, fenpyrazone, tripyrasulfone, benzofenap, pyrasulfotole, pyrazolynate, pyrazoxyfen, tolpyralate; Benzoylbicyclooctanedione: benzobicyclon; Triketone: mesotrione, tembotrione, sulcotrione, tefuryltrione, fenquinotrione, lancotrione sodium, benquitrione, dioxopyritrione; Isoxazoles: isoxaflutole; bicyclo ring compound: bicyclopyrone; others: topramezone, rimisoxafen; Tyrosine Aminotransferase: cinmethylin, methiozolin.

Inhibition of dihydroorotate dehydrogenase (DHODH): tetflupyrolimet.

HTS (homogentisate solanesyltransferase)—a downstream enzyme of HPPD: cyclopyrimorate.

Very Long Chain Fatty Acid Inhibitors: Isoxazoline: pyroxasulfone, Triazolinone: ipfencarbazone, Trifluoromethansulfonanilides: dimesulfazet, others: fenoxasulfone.

Inhibition of lycopene cyclase: amitrole.

Inhibition of Solanesyl Diphosphate Synthase (SDS): aclonifen.

Inhibition of serine-threonine protein phosphatase: endothall.

Unknown mode of action: bromobutide, pelargonic acid, diphenamid, naproanilide, napropamide, copper (salt), epyrifenacil, bixzolone, cyprosulfamide, dietholate, isoxadifen/isoxadifen ethyl, dicyclonon, benoxacor, mefenpyr ethyl, fenchlorazole ethyl, cloquintocet/cloquintocet mexyl, oxabetrinil, naphthalic anhydride, mephenate, mefenpyr, furilazole, fluxofenim, flurazole, fenclorim, fenchlorazole, dichlormid, cyometrinil.

### Plant Health Additives:

Plant health additives are products that reduce the need for fertilizers and increase plant growth, resistance to water and abiotic stresses. In small concentrations, these substances are efficient, favoring the good performance of the plant's vital processes, and allowing high yields and good quality products. In addition, plant health additives applied to plants enhance nutrition efficiency, abiotic stress tolerance and/or plant quality traits, regardless of its nutrient contents. Several researches have been developed in order to evaluate the plant health additives in improving plant development subjected to stresses, saline environment, and development of seedlings, among others. Furthermore, various raw materials have been used in plant health additives compositions, such as humic acids, hormones, algae extracts, and plant growth-promoting bacteria. In this sense, this chapter aims to approach the use of plant health additives in plant growth according to the raw material used in their compositions as well as their effects on plants subjected to abiotic stresses.

In an embodiment of the present invention, plant health additives are selected from bio-stimulants, plant growth regulators, microbial agents and micronutrients or mixture thereof.

In further embodiment of the present invention, plant health additives are selected from Bio stimulants are humic acid (salts), fulvic acid (salts), amino acids (alanine, arginine, aspartic acid, cysteine, glutamic acid, glycine, histidine, isoleucine, leucine, lysine, methionine, phenylalanine, proline, serine, threonine, tryptophan, tyrosine, valine or mixture thereof), protein hydrolysates, peptides, organic acid, acetyl thioproline, thiazolidine carboxylic acid, jasmonic acid, methyl jasmonate, chitosan, chitin, Probenazole, acibenzolar-s-methyl, seaweed extract (Ascophyllum nodosum), polyamines, silicic acid (salts)-orthosilicic acid (H4Si04), salicylic acid, lactic acid, phenyl lactic acid, fumaric acid, acibenzolar-s-methyl, nitrobenzene, (Homo)brassinolide, forchlorfenuron, triacontanol, nitrophenolate (sodium para-nitrophenolate, ortho-nitrophenolate, sodium-5-nitroguaiacolate or mixture thereof, Plant growth regulators are Auxins: Indole acetic acid, Indole butyric acid, alpha-naphthyl acetic acid; Cytokinins: kinetin, zeatin, 6-benzylaminopurine, 6-benzyladenine, dipheylurea, thidiazuron, anisiflupurin; Ethylene modulators: aviglycine, prohexadione, prohexadione calcium, trinexapac, trinexapac-ethyl, aminoethoxyvinylglycine (AVG); Gibberellins: gibberelline, gibberellic acid, GA3; Growth inhibitors: abscisic acid, chlorpropham, flumetralin, maleic hydrazide, mepiquat, mepiquat chloride, mepiquat pentaborate; Growth retardants: chlormequat, chlormequat chloride, paclobutrazol, uniconazole-P; or mixture thereof, Microbial agents are Rhizobium spp., Azotobacter spp., Azospirillum spp., Acetobacter spp., Bacillus megaterium var. phosphaticum, Bacillus polymyxa, Bacillus licheniformis, Frateuria aurantia, Thiobacillus thiooxidans, VAM (Vesicular Arbuscular Mycorrhiza) (Acaulospora spp., Gigaspora spp., Sclerocystis spp., Scutellospora spp., Glomus spp. Etc.), Acinetobacter calcoaceticus, Bacillus subtilis, Bacillus thuringiensis var. kurstaki, Pseudomonas fluorescens, Beauveria bassina, Metarrhizium anisopliae, Varticillium lecanii, Trichoderma viride, Trichoderma harzianum, Paecilomyces lilacinus, Trichoderma spp. etc. or mixture thereof; Micronutrients are zinc (zinc sulphate heptahydrate, zinc sulphate mono hydrate, Zn-EDTA, zinc oxide, zinc lactate gluconate, zinc polyflavonoid), ferrous sulphate, copper sulphate, Manganese sulphate, boron (borax-sodium tetraborate, boric acid (H₃BO₃), di-sodium octa borate tetra hydrate (Na2B8O13·4H2O), di-sodium tetra borate penta hydrate, anhydrous borax,) and sulphur (elemental sulphur, bentonite sulphur, boronated sulphur or a sulphate and thiosulphate salt) or mixture thereof.

The present OD (Oil Dispersion) formulation provides
Improved leaf penetration of spray droplets, retard evaporation loss and enhance the absorption of active ingredients;
Increase spreading properties on leaf surfaces, better wetting of waxy leaf surfaces;
Increase penetration of active ingredients into the insect cuticles and insects with waxy cuticles like mealybug and scale insects;
Improve leaf penetration of spray droplets and enhanced wetting on tough to kill weeds;
Improve rain fast properties.

Further present invention further provides Increases in the synergistic activities between active ingredients.

The present novel synergistic OD formulation improves the residual control i.e. enhance the duration of control of insect-pests and mites, fungal and bacterial diseases and weed control.

The inventor has found that with the novel recipe of OD formulation, we can reduce the doses of active ingredients and thereby minimizing the pesticidal load into the environment.

The present novel OD formulations composition is without aromatic solvent, so it's safe to the applicator and reducing the loading of aromatic solvent into the environment.

Oil Dispersion formulation of the present invention comprises carrier and solvent as Pongamia, Palm or jojoba oil. Due to High flash point (smoke points) of Pongamia (>220 Celcius), Palm oil (>240° C.), Jojoba oil (>290° C.), the novel recipe of OD formulations are more stable and safer for storage at elevated temperature. Therefore the present novel recipe of OD formulations has thermal and chemical stability over a broad range of conditions.

The novel recipe of OD formulations has better pourability, so it will minimize the wastage. The novel recipe of OD formulations are stable with wider pH range.

In the composition of the present OD formulation, we can reduces the toxicity hazards to the applicators, i.e. improves the safety of applicators at the time of handling and spraying the pesticides.

The process for preparing the present synergistic oil dispersion formulation can be modified accordingly by any person skilled in the art based on the knowledge of manufacturing the formulation. However all such variations and modifications are covered by the scope of the present invention.

The composition of the present invention in addition to bioactive amounts of active ingredients further comprises inactive excipients including but not limited to Super Wetting-spreading-penetrating agent, carrier or solvent, dispersant or dispersing agent, emulsifying agent, anti-freezing agent, anti-foam agent, preservatives and buffering agent.

Examples of super wetting-spreading-penetrating agent used herein for present OD (Oil Dispersion) formulation include but not limited to Polyalkyleneoxide modified Heptamethyl trisiloxane (Modified trisiloxane).

### Polyalkyleneoxide Modified Heptamethyltrisiloxane:

Polyalkyleneoxide modified heptamethyltrisiloxane can improve the prevention effect of pesticides and reduce the spray volume. It is used in the fields of pesticides herbicides, insecticides, acaricides, fungicides, plant growth regulating agents, and other aspects. (Polyalkyleneoxide modified heptamethyltrisiloxane, a registered product of GE Silicones)

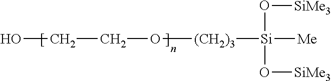

(C₂H₄O)n·C₁₁H₃₀O₃Si₃ Molecular formula:

Examples of Carrier or solvents used herein for present Oil dispersion (OD) formulation include but not limited to Pongamia/karanja/karanj (Millettia pinnata/Pongamia pinnata/Pongamia glabra) oil alone; or Palm (Elaeis spp.) oil (Palm oil and palm kernel oil) alone; or Blend of Pongamia oil and palm oil; or Blend of Pongamia oil and Jojoba (Simmondsia chinensis); or Blend of Palm oil and Jojoba oil; or Blend of Pongamia oil and vegetable oil; or Blend of Palm oil and vegetable oil; or Blend of Pongamia oil, Palm oil and vegetable oil; the vegetable oil may be any one or mixture of two or more selected from soybean (Glycine max) oil, groundnut (Arachis hypogaea) oil, rapeseed (Brassica napus subspecies) oil, mustard (Brassica juncea) oil, sesame (Sesamum indicum) oil, Corn (Zea mays) oil, rice (Oryza sativa) bran oil, castor (Ricinum communis) seed oil, cotton (Gossypium hirsutum) seed oil, linseed (Linum usitatissimum), coconut (Cocos nucifera) oil, Kapok (Ceiba pentandra) oil, Papaya (Carica papaya) seed oil, Tea seed (Camellia oleifera) oil, sunflower (Helianthus annuus) oil, safflower (Carthamus tinctorius) seed oil, Eucalyptus (Eucalyptus globulus) oil, Olive (Olea europaea) oil, Jatropha (Jatropha curcas) oil, Garlic acid (Allium sativum), Ginger oil (Zingiber officinale), D-limonene, Citronella oil or Ceylon ironwood (Mesua ferrea) oil, Mahua (Madhuca longifolia) oil.

All the solvents or combination or blend thereof, used hereby for the present OD formulation may be present in their alkylated or ethoxylated or epoxylated or esterified form.

All the said oils used as a carrier or diluent are procured from the vendor based in Gujarat State.

Examples of Carrier or solvents used herein for present Oil dispersion (OD) formulation include but not limited to Pongamia/karanja/karanj (Millettia pinnata/Pongamia pinnata/Pongamia glabra) oil alone; or Palm (Elaeis spp.) oil (Palm oil and palm kernel oil) alone; or Blend of Pongamia oil and palm oil; or Blend of Pongamia oil and Jojoba (Simmondsia chinensis); or Blend of Palm oil and Jojoba oil; or Blend of Pongamia oil and vegetable oil; or Blend of Palm oil and vegetable oil; or Blend of Pongamia oil, Palm oil and vegetable oil.

### Pongamia Oil/Karanja Oil:

Pongamia oil is derived from the seeds of the Millettia pinnata tree, which is native to tropical and temperate Asia. Millettia pinnata, also known as Pongamia pinnata or Pongamia glabra, is common throughout Asia and thus has many different names in different languages, many of which have come to be used in English to describe the seed oil derived from M. pinnata; Pongamia is often used as the generic name for the tree and is derived from the genus the tree was originally placed in. Other names for this oil include honge oil, kanuga oil, karanja oil, and pungai oil.

Pongamia oil is extracted from the seeds by expeller pressing, cold pressing, or solvent extraction. The oil is yellowish-orange to brown in colour. It has a high content of triglycerides, and its disagreeable taste and odour are due to bitter flavonoid constituents including karanjin, pongamol, tannin and karanjachromene. The physical properties of crude Pongamia oil are as flash point of the Pongamia oil is 225° C.

Its fruits are used in abdominal remedies. Its seeds are used in tumor treatment. Oil is used for curing rheumatism. Leaves are used against Micrococcus. Their leaves juices are used for the treatment of diarrhea cold and cough. It has curative effect for leucoderma and itches. Its oil is used as a lubricant, water paint binder. Utilization of Seed Cake as a Manure for having the proper N, P & K content and ratio. As a material for biogas (Methane) production. As a Material for Producing Proteins for Food, Pharmaceutical and Industrial Applications by Chemical and Biochemical Technologies. Production of Soluble Fibers for Food Uses.

It is medium sized tree and is found throughout India. The tree is drought resistant. Major producing countries are East Indies, Philippines, and India. The oil content varies from 27-39%. Its cake is used as pesticide and fertilizer. The deoiled cake when applied to soil, has pesticidal value, especially against nematodes and also helps in improving soil fertility. Karanja is often planted in home steads as a shade or ornamental tree and in avenue planting along roadside and canals. It is preferred species help in controlling soil erosion and binding sand dunes due to its dense network of lateral roots.

The persistence of karanj is greater than other tested botanical insecticides. The dosages at 1 and 2% of karanj oil give better control of insect pests compared with lower concentrations. Karanj oil and karanjin shows greater biological activity than other karanj extracts. The karanj oil shows good synergistic effect with a number of chemical insecticides. Therefore, karanj has great potential to be used as biopesticide because of its antifeedant; oviposition deterrent, ovicidal, roachicidal, juvenile hormone activity and insecticidal properties against a wide range of insect pests [Mukesh Kumar a & Ram Singh, Department of Entomology, Potential of Pongamia glabra Vent as an Insecticide of Plant Origin, CCS Haryana, Agricultural University, Hisar, 125 004, India, Published online: 24 Apr. 2012].

Botanical pesticides are also very potent insecticides and, due to their composition, they can help to fight the global problem of insects developing resistance to insecticides. Insecticides based on karanja oil shows efficiency against L. decemlineata larvae at different concentrations [Katerina Kovarikova and Roman Pavela; United Forces of Botanical Oils: Efficacy of Neem and Karanja Oil against Colorado Potato Beetle under Laboratory Conditions; Plants 2019, 8, 608; doi:10.3390/plants8120608].

### Palm Oil

Palm oil is an edible vegetable oil derived from the mesocarp (reddish pulp) of the fruit of the oil palms, primarily the African oil palm Elaeis guineensis, and to a lesser extent from the American oil palm Elaeis oleifera and the maripa palm Attalea maripa.

The use of palm oil in food and beauty products has attracted the concern of environmental groups; the high oil yield of the trees has encouraged wider cultivation, leading to the clearing of forests in parts of Indonesia and Malaysia to make space for oil-palm monoculture. This has resulted in significant acreage losses of the natural habitat of the three surviving species of orangutan. One species in particular, the Sumatran orangutan, has been listed as critically endangered.

PME (Palm-based Methyl Esters) as carrier solvents appear to enhance pesticide efficacy, which may allow for a reduction in dosage or frequency of application, help to control adverse effects and reduce the cost spent on pesticides. Therefore, PME as a carrier solvent in pesticide formulations is a promising prospect for the agrochemical industry [Sumaiyah Megat Nabil Mohsin; Ismail Ab Raman; Zafarizal Aldrin Azizul Hasan and Zainab Idris; Palm-based Methyl Esters as Carrier Solvents in pesticide Formulations, Technical Report, January 2018, Page no. 32-38].

### Jojoba Oil:

Jojoba oil is the liquid produced in the seed of the Simmondsia chinensis (jojoba) plant, a shrub, which is native to southern Arizona, southern California, and northwestern Mexico. The oil makes up approximately 50% of the jojoba seed by weight. The terms “jojoba oil” and “jojoba wax” are often used interchangeably because the wax visually appears to be a mobile oil, but as a wax it is composed almost entirely (˜97%) of mono-esters of long-chain fatty acids and alcohols (wax ester), accompanied by only a tiny fraction of triglyceride esters. This composition accounts for its extreme shelf-life stability and extraordinary resistance to high temperatures, compared with true vegetable oils.

Jojoba oil shows an insecticidal activity. At lower as well has higher concentration jojoba oil has insecticdal properties and can be use plant protection management [Tahany, R. Abd El-Zaher; Biological Activity of Four Plant Oils in the Form of Nano Products on the Larvae of Cotton leaf worm; Middle East Journal of Applied Sciences; Volume: 07, Issue: 02, April-June 2017, Pages: 239-249].

### Vegetable Oil.

The term “vegetable oil” can be narrowly defined as referring only to substances that are liquid at room temperature, or broadly defined without regard to a substance's state (liquid or solid) at a given temperature. While a large majority of the entries in this list fit the narrower of these definitions, some do not qualify as vegetable oils according to all understandings of the term.

Vegetable oils are triglycerides extracted from plants. Some of these oils have been part of human culture for millennia. Edible vegetable oils are used in food, both in cooking and as supplements. Many oils, edible and otherwise, are burned as fuel, such as in oil lamps and as a substitute for petroleum-based fuels. Some of the many other uses include wood finishing, oil painting, and skin care.

Vegetable oils, or vegetable fats, are oils extracted from seeds or from other parts of fruits. Like animal fats, vegetable fats are mixtures of triglycerides. Soybean oil, grape seed oil, and cocoa butter are examples of fats from seeds. Olive oil, palm oil, and rice bran oil are examples of fats from other parts of fruits. In common usage, vegetable oil may refer exclusively to vegetable fats which are liquid at room temperature. Vegetable oils are usually edible; non-edible oils derived mainly from petroleum are termed mineral oils.

Most, but not all vegetable oils are extracted from the fruits or seeds of plants. For instance, palm oil is extracted from palm fruits, while soybean oil is extracted from soybean seeds. Vegetable oils may also be classified by grouping oils extracted from similar plants, such as “nut oils”. Although most plants contain some oil, only the oil from certain major oil crops complemented by a few dozen minor oil crops is widely used and traded.

Oils from plants are used for several different purposes. Edible vegetable oils may be used for cooking, or as food additives. Many vegetable oils, edible and otherwise, are burned as fuel, for instance as a substitute for petroleum-based fuels. Some may be also used for cosmetics, medical purposes, wood finishing, oil painting, formulation ingredient in many pharmaceutical or agricultural formulations and other industrial purposes.

The vegetable Oil for preparing blend with palm oil or jojoba oil or karank oil used herein used herein as solvent or carrier for present Oil dispersion (OD) formulation include but not limited to any one or mixture of two or more selected from soybean (Glycine max) oil, groundnut (Arachis hypogaea) oil, rapeseed (Brassica napus subspecies) oil, mustard (Brassica juncea) oil, sesame (Sesamum indicum) oil, Corn (Zea mays) oil, rice (Oryza sativa) bran oil, castor (Ricinum communis) seed oil, cotton (Gossypium hirsutum) seed oil, linseed (Linum usitatissimum), coconut (Cocos nucifera) oil, Kapok (Ceiba pentandra) oil, Papaya (Carica papaya) seed oil, Tea seed (Camellia oleifera) oil, sunflower (Helianthus annuus) oil, safflower (Carthamus tinctorius) seed oil, Eucalyptus (Eucalyptus globulus) oil, Olive (Olea europaea) oil, Jatropha (Jatropha curcas) oil, Garlic acid (Allium sativum), Ginger oil (Zingiber officinale), D-limonene, Citronella oil or Ceylon ironwood (Mesua ferrea) oil, Mahua (Madhuca longifolia) oil.

A dispersant or a dispersing agent is a substance which adsorbs onto the surface of particles and helps to preserve the state of dispersion of the particles and prevents them from re-aggregating. Dispersants are added to agrochemical formulations to facilitate dispersion and suspension during manufacture, and to ensure the particles re-disperse into water in a spray tank. They are widely used in wettable powders, suspension concentrates and water-dispersible granules. Surfactants that are used as dispersants have the ability to adsorb strongly onto a particle surface and provide a charged or steric barrier to re-aggregation of particles. The most commonly used surfactants are anionic, non-ionic, or mixtures of the two types. For wettable powder formulations, the most common dispersants are sodium lingo sulphonates. In recent years, new types of very high molecular weight polymeric surfactants have been developed as dispersants.

These have very long hydrophobic ‘backbones’ and a large number of ethylene oxide chains forming the ‘teeth’ of a ‘comb’ surfactant. These high molecular weight polymers can give very good long-term stability to suspension concentrates because the hydrophobic backbones have many anchoring points onto the particle surfaces.

Examples of dispersing agent used herein for used herein for present OD (Oil Dispersion) formulation include but not limited to alkyl sulfonates, alkyl benzene sulfonates, alkyl aryl sulfonates, alkylphenolalkoxylates, tristyrylphenol ethoxylates, natural or synthetic fatty ethoxylate alcohols, natural or synthetic fatty acid alkoxylates, natural or synthetic fatty alcohols alkoxylates, alkoxylated alcohols (such as n-butyl alcohol poly glycol ether), block copolymers (such as ethylene oxide-propylene oxide block copolymers and ethylene oxide-butylene oxide block copolymers), fatty acid-polyalkylene glycol condensates, polyamine-fatty acid condensates, polyester condensates, salts of polyolefin condensates, sodium ligno sulfonate, sodium ploycarboxylate, EO/PO based copolymer, phenol sulfonate, sodium methyl oleoyl taurate, styrene acrylic acid copolymer, propyleneoxide-ethyleneoxide-copolymer, polyethylene glycol 2,4,6-tristyrylphenyl ether, tristyrylphenol-polyglycolether-phosphate, tristyrylphenole with 16 moles EO, tristyrylphenol-polyglycolether-phosphate, oleyl-polyglycolether with ethylene oxide, tallow fattyamine polyethylene oxide, nonylphenol polyglycolether with 9-10 moles ethylene oxide.

Antifoaming agent for the present formulation is selected from various compounds and selectively used according to the formulation. Generally, there are two types of antifoam agents, namely silicones and non-silicones. Silicones are usually aqueous emulsions of dimethyl poly siloxane while the non-silicone anti-foam agents are water-insoluble oils, such as octanol and nonanol, or silica. In both cases, the function of the anti-foam agent is to displace the surfactant from the air-water interface.

Examples of Antifoaming agent used herein for present Oil dispersion (OD) formulation include but not limited to silicone oil, silicone compound, C10˜C20 saturated fat acid compounds or C8˜C10 aliphatic alcohols compound, silicone antifoam emulsion, dimethyl siloxane, poly dimethyl siloxane, vegetable oil based antifoam, tallow based fatty acids, polyalkylene oxide modified polydimethylsiloxane.

Examples of Anti-freezing agent used herein for present Oil dispersion (OD) formulation include but not limited ethylene glycol, propane diols, glycerine or the urea, glycol (Monoethylene glycol, Diethylene glycol, Polypropylene glycol, Polyethylene glycol), glycerine, urea, magnesium sulfate heptahydrate, sodium chloride.

Preservative used herein for the present Oil dispersion (OD) formulation include but not limited to 1,2-benzisothiazolin-3(2H)-one, sodium salt, Sodium benzoate, 2-bromo-2-nitropropane-1,3-diol, Formaldehyde, Sodium o-phenylphenate, 5-chloro-2-methyl-4-isothiazolin-3-one & 2-methyl-4-isothiazolin-3-one.

Emulsifying agent used herein for the present Oil dispersion (OD) formulation includes but not limited to castor oil ethoxylates, alcohol ethoxylates, fatty acid ethoxylates, sorbitan ester ethoxylates, sulphosuccinate, calcium salts of dodecylbenzene sulphonate, alkylammonium salts of alkylbenzene sulphonate, alkylsulphosuccinate salts, ethylene oxide-propylene oxide block copolymers, ethoxylated alkylamines, ethoxylated alkyl phenols, polyoxyethylenesorbitan monolaurate.

Stabilizers or stabilizing agent used herein for the present Oil dispersion (OD) formulation includes but not limited to hectorite clay, aluminum magnesium silicate, bentonite clay, silica, attapulgite clay.

Examples of Buffering agent used herein for the present Oil dispersion (OD) formulation include but not limited to Citric acid, sodium carbonate, sodium bicarbonate, sulphuric acid, hydrochloric acid, sodium hydroxide, potassium hydroxide, acetic acid, sorbic acid.

Buffering agent used herein for the present Oil dispersion (OD) formulation includes but not limited to calcium hydroxyapatite, Potassium Dihydrogen Phosphate, Sodium Hydroxide, carbonated apatite, calcium carbonate, sodium bicarbonate, tricalcium phosphate, calcium phosphates, carbonated calcium phosphates, amine monomers, lactate dehydrogenase and magnesium hydroxide.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. The invention shall now be described with reference to the following specific examples. It should be noted that the example(s) appended below illustrate rather than limit the invention, and that those skilled in the art will be able to design many alternative embodiments without departing from the scope of the present invention.

These and other aspects of the invention may become more apparent from the examples set forth herein below. These examples are provided merely as illustrations of the invention and are not intended to be construed as a limitation thereof.

### Example 1

### Procedure: Manufacturing Process of Novel Oil Dispersion (OD) Formulation:

Preparation of Oil dispersion (OD) formulation:

| Part A | Preparation of the liquid premix |
|---|---|
| Step 1 | Charge Vegetable oil (pongamia oil or palm oil or pongamia oil + palm oil |
| | or pongamia oil + jojoba oil or palm oil + jojoba oil or pongamia |
| | oil + vegetable oil or paml oil + vegetable oil or pongamia oil + palm |
| | oil + vegetable oil) or solvent or both into a vessel with anchor stirrer. |
| Step 2 | Under stirring, add the emulsifier/super wetting-spreading-penetrating |
| | agent (Polyalkyleneoxide modified Heptamethyl trisiloxane) and |
| | dispersing agent and stir until all ingredients are dissolved completely. |
| Part B | Preparation of the slurry |
| Step 1 | Now, charge the liquid premix into a second vessel, equipped with a |
| | cooling and heating device and a high shear stirrer. |
| Step 2 | Add the active ingredient(s) and homogenize thoroughly. Pre-mill this |
| | mixture and finally mill it using a bead mill/sand mill/attritor to achieve a |
| | particle size distribution as required by the specification. |
| Part C | Preparation of the Thickener gel |
| Step 1 | Charge the remaining oil or solvent to the vessel, equipped with a high |
| | shear stirrer. |
| Step 2 | Add gradually the thickener which is organophilic clay, maintaining high- |
| | shear mixing throughout. Stirring is continued until thoroughly mixed. |
| Step 3 | Under stirring, the thickener activating agent propylene carbonate is |
| | added. Allow the gel to swell whilst maintaining mixing. |
| Part D | Preparation of the final formulation |
| Step 1 | Now add the thickener gel or silica and disperse the mixture by using a |
| | high shear stirrer. |
| Step 2 | Check the finished formulation to specification. |
| Step 3 | After approval, material is packed in required pack sizes. |

### Example 2: Novel OD Formulation Recipes of Cyantraniliprole

### (Recipe a, Recipe B, Recipe C, Recipe D, Recipe E, Recipe F)

### Example 2A: Cyantraniliprole 10.26% OD (Recipe A)

| Chemical composition | % (w/w) |
|---|---|
| Cyantraniliprole a.i. | 10.00 |
| Dodecyl benzene sulphonate | 25.00 |
| Tristyrylphenol-polyglycolether-phosphate | 5.00 |
| Fumed silica | 1.31 |
| Citric acid | 0.02 |
| Propylene glycol | 5.00 |
| 1,2-benzisothiazolin-3(2H)-one | 0.20 |
| Polyalkyleneoxide modified Heptamethyl trisiloxane | 5.00 |
| Methyl ester of pongamia oil | 48.47 |
| Total | 100.00 |

### Example 2B: Cyantraniliprole 10.26% OD (Recipe B)

| Chemical composition | % (w/w) |
|---|---|
| Cyantraniliprole a.i. | 10.00 |
| Dodecyl benzene sulphonate | 25.00 |
| Tristyrylphenol-polyglycolether-phosphate | 5.00 |
| Fumed silica | 1.31 |
| Citric acid | 0.02 |
| Propylene glycol | 5.00 |
| 1,2-benzisothiazolin-3(2H)-one | 0.20 |
| Polyalkyleneoxide modified Heptamethyl trisiloxane | 5.00 |
| Methyl ester of palm oil | 48.47 |
| Total | 100.00 |

### Example 2C: Cyantraniliprole 10.26% OD (Recipe C)

| Chemical composition | % (w/w) |
|---|---|
| Cyantraniliprole a.i. | 10.00 |
| Dodecyl benzene sulphonate | 25.00 |
| Tristyrylphenol-polyglycolether-phosphate | 5.00 |
| Fumed silica | 1.31 |
| Citric acid | 0.02 |
| Propylene glycol | 5.00 |
| 1,2-benzisothiazolin-3(2H)-one | 0.20 |
| Polyalkyleneoxide modified Heptamethyl trisiloxane | 5.00 |
| Blend of Methyl ester of pongamia oil and palm oil | 48.47 |
| Total | 100.00 |

### Example 2D: Cyantraniliprole 10.26% OD (Recipe D)

| Chemical composition | % (w/w) |
|---|---|
| Cyantraniliprole a.i. | 10.00 |
| Dodecyl benzene sulphonate | 25.00 |
| Tristyrylphenol-polyglycolether-phosphate | 5.00 |
| Fumed silica | 1.31 |
| Citric acid | 0.02 |
| Propylene glycol | 5.00 |
| 1,2-benzisothiazolin-3(2H)-one | 0.20 |
| Polyalkyleneoxide modified Heptamethyl trisiloxane | 5.00 |
| Blend of Methyl ester of pongamia oil and soybean oil | 48.47 |
| Total | 100.00 |

### Example 2E: Cyantraniliprole 10.26% OD (Recipe E)

| Chemical composition | % (w/w) |
|---|---|
| Cyantraniliprole a.i. | 10.00 |
| Dodecyl benzene sulphonate | 25.00 |
| Tristyrylphenol-polyglycolether-phosphate | 5.00 |
| Fumed silica | 1.31 |
| Citric acid | 0.02 |
| Propylene glycol | 5.00 |
| 1,2-benzisothiazolin-3(2H)-one | 0.20 |
| Polyalkyleneoxide modified Heptamethyl trisiloxane | 5.00 |
| Blend of Methyl ester of palm oil and soybean oil | 48.47 |
| Total | 100.00 |

### Example 2F: Cyantraniliprole 10.26% OD (Recipe F)

| Chemical composition | % (w/w) |
|---|---|
| Cyantraniliprole a.i. | 10.00 |
| Dodecyl benzene sulphonate | 25.00 |
| Tristyrylphenol-polyglycolether-phosphate | 5.00 |
| Fumed silica | 1.31 |
| Citric acid | 0.02 |
| Propylene glycol | 5.00 |
| 1,2-benzisothiazolin-3(2H)-one | 0.20 |
| Polyalkyleneoxide modified Heptamethyl trisiloxane | 5.00 |
| Blend of Methyl ester of pongamia oil, | 48.47 |
| palm oil and soybean oil | |
| Total | 100.00 |

### Example 2G: Prior Art Recipe of Cyantraniliprole 10.26% OD* (Recipe-Prior Art OD)

| Chemical composition | % (w/w) |
|---|---|
| Cyantraniliprole a.i. | 10.00 |
| Dodecyl benzene sulphonate in methylated | 25.00 |
| and ethoxylated seed oil | |
| Tristyrylphenol-polyglycolether-phosphate | 5.00 |
| Fumed silica | 1.31 |
| Citric acid | 0.02 |
| Propylene glycol | 5.00 |
| 1,2-benzisothiazolin-3(2H)-one | 0.20 |
| Polyoxyethylene sorbitol fatty acid | 5.00 |
| Methylated seed oil | 48.47 |
| Total | 100.00 |

*Brand name- Benevia by FMC India Pvt. Ltd.

### Example 2H: Prior Art Recipe of Cyantraniliprole 20% SC (Recipe-Prior Art SC)

| Chemical composition | % (w/w) |
|---|---|
| Cyantraniliprole a.i. | 20.00 |
| Methylmethacrylate ethoxylated graft co-polymer | 3.00 |
| Ethyleneoxide/propyleneoxide block | 2.00 |
| co-polymer and ethoxylated alcohol | |
| Attapulgite clay | 1.00 |
| Xanthan gum | 0.3 |
| 1,2-benzisothiazolin-3(2H)-one | 0.1 |
| Silicone emulsion | 0.50 |
| Propylene glycol | 6.80 |
| Water | 66.30 |
| Total | 100.00 |

### Example 3: Novel OD Formulation Recipes of Spirotetramat

### (Recipe-A-SPTMT), (Recipe-B-SPTMT), (Recipe-C-SPTMT), (Recipe-D-SPTMT)

### Example 3A: Spirotetramat 15.31% w/w OD (Recipe-A-SPTMT)

| Chemical composition | % (w/w) |
|---|---|
| Spirotetramat a.i. | 15.31 |
| Propoxylated Ethoxylated copolymer monoalkylethers | 20.00 |
| Fatty alcohols; ethoxylated preparation | 3.00 |
| Napthalene sulfonate condensed | 0.50 |
| with formaldehyde; preparation | |
| Polydimethylsiloxane | 0.05 |
| Butyl hydroxyl toluene | 0.20 |
| Citric acid | 0.20 |
| Polyalkyleneoxide modified Heptamethyl trisiloxane | 5.00 |
| Blend of Methyl ester of pongamia oil and palm oil | 55.74 |
| Total | 100.00 |

### Example 3B: Spirotetramat 15.31% w/w OD (Recipe-B-SPTMT)

| Chemical composition | % (w/w) |
|---|---|
| Spirotetramat a.i. | 15.31 |
| Propoxylated Ethoxylated copolymer monoalkylethers | 20.00 |
| Fatty alcohols; ethoxylated preparation | 3.00 |
| Napthalene sulfonate condensed | 0.50 |
| with formaldehyde; preparation | |
| Polydimethylsiloxane | 0.05 |
| Butyl hydroxyl toluene | 0.20 |
| Citric acid | 0.20 |
| Polyalkyleneoxide modified Heptamethyl trisiloxane | 5.00 |
| Blend of Methyl ester of pongamia oil and rapeseed oil | 55.74 |
| Total | 100.00 |

### Example 3C: Spirotetramat 15.31% w/w OD (Recipe-C-SPTMT)

| Chemical composition | % (w/w) |
|---|---|
| Spirotetramat a.i. | 15.31 |
| Propoxylated Ethoxylated copolymer monoalkylethers | 20.00 |
| Fatty alcohols; ethoxylated preparation | 3.00 |
| Napthalene sulfonate condensed | 0.50 |
| with formaldehyde; preparation | |
| Polydimethylsiloxane | 0.05 |
| Butyl hydroxyl toluene | 0.20 |
| Citric acid | 0.20 |
| Polyalkyleneoxide modified Heptamethyl trisiloxane | 5.00 |
| Blend of Methyl ester of palm oil and rapeseed oil | 55.74 |
| Total | 100.00 |

### Example 3D: Spirotetramat 15.31% w/w OD (Recipe-D-SPTMT)

| Chemical composition | % (w/w) |
|---|---|
| Spirotetramat a.i. | 15.31 |
| Propoxylated Ethoxylated copolymer monoalkylethers | 20.00 |
| Fatty alcohols; ethoxylated preparation | 3.00 |
| Napthalene sulfonate condensed | 0.50 |
| with formaldehyde; preparation | |
| Polydimethylsiloxane | 0.05 |
| Butyl hydroxyl toluene | 0.20 |
| Citric acid | 0.20 |
| Polyalkyleneoxide modified Heptamethyl trisiloxane | 5.00 |
| Blend of Methyl ester of pongamia oil, | 55.74 |
| palm oil and rapeseed oil | |
| Total | 100.00 |

### Example 3E: Prior Art Recipe of Spirotetramat 15.31% w/w OD*

| Chemical composition | % (w/w) |
|---|---|
| Spirotetramat a.i. | 15.31 |
| Propoxylated Ethoxylated copolymer monoalkylethers | 20.00 |
| Fatty alcohols; ethoxylated preparation | 3.00 |
| Napthalene sulfonate condensed | 0.50 |
| with formaldehyde; preparation | |
| Polydimethylsiloxane | 0.05 |
| Butyl hydroxyl toluene | 0.20 |
| Citric acid | 0.20 |
| Ethoxylated sorbitol oleates | 5.00 |
| Fatty acids glycerides | 55.74 |
| Total | 105.00 |

*Brand name- Movento by Bayer CropScience Ltd.

### Example 3F: Prior Art Recipe-Spirotetramat 24% SC (Recipe-Prior Art SC)

| Chemical composition | % (w/w) |
|---|---|
| Spirotetramat a.i. | 24.00 |
| Methylmethacrylate ethoxylated graft co-polymer | 3.00 |
| Ethyleneoxide/propyleneoxide block | 2.00 |
| co-polymer and ethoxylated alcohol | |
| Attapulgite clay | 1.00 |
| Xanthan gum | 0.3 |
| 1,2-benzisothiazolin-3(2H)-one | 0.1 |
| Silicone emulsion | 0.50 |
| Propylene glycol | 6.80 |
| Water | 62.30 |
| Total | 100.00 |

### Example 4: Novel OD Formulation Recipes of Betacyfluthrin+Imidacloprid^{PG}-6^{T}

### (Recipe A-BI), (Recipe B-BI), (Recipe C-BI)

### Example 4A: Betacyfluthrin 8.49% w/w+Imidacloprid 19.81% w/w OD (Recipe A-BI) Chemical Composition % W/W

| Chemical composition | % (w/w) |
|---|---|
| Betacyfluthrin a.i. | 8.48 |
| Imidacloprid a.i. | 19.81 |
| Preparation of condensed naphthalene sulfonate | 0.50 |
| Propoxylated Ethoxylated copolymer | 15.00 |
| monoalkylether (ethylhexanol) | |
| Cyclohexanone | 15.00 |
| Polydimethylsiloxane | 0.05 |
| Butyl hydroxyl toluene | 0.20 |
| Ethoxylated sorbitol oleates | 10.00 |
| Citric acid | 0.20 |
| Polyalkyleneoxide modified Heptamethyl trisiloxane | 5.00 |
| Blend of Methyl ester of pongamia oil and sunflower oil | 25.76 |
| Total | 100.00 |

### Example 4B: Betacyfluthrin 8.49% w/w+Imidacloprid 19.81% w/w OD (Recipe B-BI)

| Chemical composition | % (w/w) |
|---|---|
| Betacyfluthrin a.i. | 8.48 |
| Imidacloprid a.i. | 19.81 |
| Preparation of condensed naphthalene sulfonate | 0.50 |
| Propoxylated Ethoxylated copolymer | 15.00 |
| monoalkylether (ethylhexanol) | |
| Cyclohexanone | 15.00 |
| Polydimethylsiloxane | 0.05 |
| Butyl hydroxyl toluene | 0.20 |
| Ethoxylated sorbitol oleates | 10.00 |
| Citric acid | 0.20 |
| Polyalkyleneoxide modified Heptamethyl trisiloxane | 5.00 |
| Blend of Methyl ester of palm oil and sunflower oil | 25.76 |
| Total | 100.00 |

### Example 4C: Betacyfluthrin 8.49% w/w+Imidacloprid 19.81% w/w OD (Recipe C-BI)

| Chemical composition | % (w/w) |
|---|---|
| Betacyfluthrin a.i. | 8.48 |
| Imidacloprid a.i. | 19.81 |
| Preparation of condensed naphthalene sulfonate | 0.50 |
| Propoxylated Ethoxylated copolymer | 15.00 |
| monoalkylether (ethylhexanol) | |
| Cyclohexanone | 15.00 |
| Polydimethylsiloxane | 0.05 |
| Butyl hydroxyl toluene | 0.20 |
| Ethoxylated sorbitol oleates | 10.00 |
| Citric acid | 0.20 |
| Polyalkyleneoxide modified Heptamethyl trisiloxane | 5.00 |
| Blend of Methyl ester of pongamia oil, | 25.76 |
| palm oil and sunflower oil | |
| Total | 100.00 |

### Example 4D: Prior Art Recipe-Betacyfluthrin 8.49% w/w+Imidacloprid 19.81% w/w OD* (Prior Art Recipe-BI)

| Chemical composition | % (w/w) |
|---|---|
| Betacyfluthrin a.i. | 8.49 |
| Imidacloprid a.i. | 19.81 |
| Preparation of condensed naphthalene sulfonate | 0.50 |
| Propoxylated Ethoxylated copolymer | 15.00 |
| monoalkylether (ethylhexanol) | |
| Cyclohexanone | 15.00 |
| Polydimethylsiloxane | 0.05 |
| Butyl hydroxyl toluene | 0.20 |
| Ethoxylated sorbitol oleates | 10.00 |
| Citric acid | 0.20 |
| Ethoxylated fatty alcohols | 5.00 |
| Sunflower oil | 25.76 |
| Total | 100.00 |

*Brand name- Solomon by Bayer CropScience Ltd.

### Example 5: Novel OD Formulation Recipes of Penoxsulam+Cyhalofop-butyl

### (Recipe-A-PC), (Recipe-B-PC), (Recipe-C-PC)

### Example 5A: Penoxsulam 1.02%+Cyhalofop-butyl 5.1% w/w OD (Recipe-A-PC)

| Chemical composition | % (w/w) |
|---|---|
| Penoxsulam a.i. | 1.02 |
| Cyhalofop-butyl a.i. | 5.10 |
| Acrylic copolymer blend | 0.23 |
| Calcium salts of dodecylbenzene sulphonate | 8.00 |
| Silicon dioxide | 0.46 |
| Polydimethyl siloxane | 0.30 |
| 1,2-benzisothiazolin-3(2H)-one | 0.20 |
| Propylene glycol | 5.00 |
| Polyalkyleneoxide modified Heptamethyl trisiloxane | 5.00 |
| Blend of Methyl ester of pongamia oil and sunflower oil | 74.69 |
| Total | 100.00 |

### Example 5B: Penoxsulam 1.02%+Cyhalofop-butyl 5.1% w/w OD (Recipe-B-PC)

| Chemical composition | % (w/w) |
|---|---|
| Penoxsulam a.i. | 1.02 |
| Cyhalofop-butyl a.i. | 5.10 |
| Acrylic copolymer blend | 0.23 |
| Calcium salts of dodecylbenzene sulphonate | 8.00 |
| Silicon dioxide | 0.46 |
| Polydimethyl siloxane | 0.30 |
| 1,2-benzisothiazolin-3(2H)-one | 0.20 |
| Propylene glycol | 5.00 |
| Polyalkyleneoxide modified Heptamethyl trisiloxane | 5.00 |
| Blend of Methyl ester of palm oil and sunflower oil | 74.69 |
| Total | 100.00 |

### Example 5C: Penoxsulam 1.02%+Cyhalofop-butyl 5.1% w/w OD (Recipe-C-PC)

| Chemical composition | % (w/w) |
|---|---|
| Penoxsulam a.i. | 1.02 |
| Cyhalofop-butyl a.i. | 5.10 |
| Acrylic copolymer blend | 0.23 |
| Calcium salts of dodecylbenzene sulphonate | 8.00 |
| Silicon dioxide | 0.46 |
| Polydimethyl siloxane | 0.30 |
| 1,2-benzisothiazolin-3(2H)-one | 0.20 |
| Propylene glycol | 5.00 |
| Polyalkyleneoxide modified Heptamethyl trisiloxane | 5.00 |
| Blend of Methyl ester of pongamia oil, | 74.69 |
| palm oil and sunflower oil | |
| Total | 100.00 |

### Example 5D: Prior Art Recipe—Penoxsulam 1.02%+Cyhalofop-Butyl 5.1% w/w OD* (Prior Art Recipe-PC)

| Chemical composition | % (w/w) |
|---|---|
| Penoxsulam a.i. | 1.02 |
| Cyhlofop butyl a.i. | 5.10 |
| Propylene glycol | 0.06 |
| Methylnaphthalene sulfonic acid -formaldehyde | 0.08 |
| polymer sodium salt | |
| Methyl oxirane, block copolymer | 0.02 |
| Alkylphenol alkoxylate | 38.50 |
| Polydimethylsiloxane | 0.001 |
| 1,2-benzisothiazolin-3(2H)-one | 0.0004 |
| Alkylaryl sulfonate | 1.85 |
| Oleic acid | 0.57 |
| Citric acid | 0.004 |
| Methyl soyate | 27.60 |
| Silica dimethyl silyate | 2.28 |
| Silicon dioxide | 0.46 |
| Acrylic copolymer blend | 0.23 |
| Cellulose | 0.002 |
| Xanthum gum | 0.002 |
| Water | 0.83 |
| Solvent naphta (petrolium) heavy aromatic | 21.39 |
| Total | 100.00 |

*Brand name- Vivaya by Corteva Agriscience

### Example 6: Novel OD Formulation Recipes of Prothioconazole

### (Recipe A-PRT20), (Recipe B-PRT20), (Recipe C-PRT20), (Recipe D-PRT20),

### Example 6A: Prothioconazole 20% OD (Recipe A-PRT20)

| Chemical composition | % (w/w) |
|---|---|
| Prothioconazole a.i. | 20.00 |
| Tristyrylphenol-polyglycolether-phosphate | 4.50 |
| Calcium salts of dodecylbenzene sulphonate | 8.00 |
| Bentonite clay | 1.50 |
| Polydimethyl siloxane | 0.30 |
| 1,2-benzisothiazolin-3(2H)-one | 0.20 |
| Polypropylene glycol | 5.00 |
| Polyalkyleneoxide modified Heptamethyl trisiloxane | 5.00 |
| Methyl ester of pongamia oil | 55.50 |
| Total | 100.00 |

### Example 6B: Prothioconazole 20% OD (Recip B-PRT20)

| Chemical composition | % (w/w) |
|---|---|
| Prothioconazole a.i. | 20.00 |
| Tristyrylphenol-polyglycolether-phosphate | 4.50 |
| Calcium salts of dodecylbenzene sulphonate | 8.00 |
| Bentonite clay | 1.50 |
| Polydimethyl siloxane | 0.30 |
| 1,2-benzisothiazolin-3(2H)-one | 0.20 |
| Polypropylene glycol | 5.00 |
| Polyalkyleneoxide modified Heptamethyl trisiloxane | 5.00 |
| Methyl ester of palm oil | 55.50 |
| Total | 100.00 |

### Example 6C: Prothioconazole 20% OD (Recipe C-PRT20)

| Chemical composition | % (w/w) |
|---|---|
| Prothioconazole a.i. | 20.00 |
| Tristyrylphenol-polyglycolether-phosphate | 4.50 |
| Calcium salts of dodecylbenzene sulphonate | 8.00 |
| Bentonite clay | 1.50 |
| Polydimethyl siloxane | 0.30 |
| 1,2-benzisothiazolin-3(2H)-one | 0.20 |
| Polypropylene glycol | 5.00 |
| Polyalkyleneoxide modified Heptamethyl trisiloxane | 5.00 |
| Blend of Methyl ester of pongamia oil and jojoba oil | 55.50 |
| Total | 100.00 |

### Example 6D: Prothioconazole 20% OD (Recipe D-PRT20)

| Chemical composition | % (w/w) |
|---|---|
| Prothioconazole a.i. | 20.00 |
| Tristyrylphenol-polyglycolether-phosphate | 4.50 |
| Calcium salts of dodecylbenzene sulphonate | 8.00 |
| Bentonite clay | 1.50 |
| Polydimethyl siloxane | 0.30 |
| 1,2-benzisothiazolin-3(2H)-one | 0.20 |
| Polypropylene glycol | 5.00 |
| Polyalkyleneoxide modified Heptamethyl trisiloxane | 5.00 |
| Blend of Methyl ester of palm oil and jojoba oil | 55.50 |
| Total | 100.00 |

### Example 6E: Prior Art Recipe-Prothioconazole 20% OD (Recipe-Prior Art OD) Chemical Composition % (w/w)

| Chemical composition | % (w/w) |
|---|---|
| Prothioconazole a.i. | 20.00 |
| Dodecyl benzene sulphonate in methylated | 25.00 |
| and ethoxylated seed oil | |
| Polyoxyethylene sorbitol fatty acid | 5.00 |
| Tristyrylphenol-polyglycolether-phosphate | 5.00 |
| Fumed silica | 1.31 |
| Citric acid | 0.02 |
| Propylene glycol | 5.00 |
| 1,2-benzisothiazolin-3(2H)-one | 0.20 |
| Methylated seed oil | 38.47 |
| Total | 100.00 |

### Example 6F: Prior Art Recipe—Prothioconazole 20% SC (Recipe-Prior Art SC)

| Chemical composition | % (w/w) |
|---|---|
| Prothioconazole a.i. | 20.00 |
| Methylmethacrylate ethoxylated graft co-polymer | 3.00 |
| Ethyleneoxide/propyleneoxide block co-polymer and | 2.00 |
| ethoxylated alcohol | |
| Attapulgite clay | 1.00 |
| Xanthan gum | 0.3 |
| 1,2-benzisothiazolin-3(2H)-one | 0.1 |
| Silicone emulsion | 0.50 |
| Propylene glycol | 6.80 |
| Water | 66.30 |
| Total | 100.00 |

### Example 7

### Storage Stability Studies of Novel OD Formulations Recipes Vs Prior Art OD Formulations Recipe of Cyantraniliprole

Storage stability of novel OD formulation recipe
of Cyantraniliprole 10.26% OD (Recipe A)

| | | | Laboratory | | | | |
|---|---|---|---|---|---|---|---|
| | | | storage for 14 | | | | |
| | | | days | | | | |
| | | | At | At | Room temperature storage | | |
| | Specification | | 54 ± 2° | 0 ± 2° | 1 | 6 | 12 |
| Parameters | (in house) | Initial | C. | C. | month | months | months |
| Cyantraniliprole | 9.50 to 10.50 | 10.40 | 10.10 | 10.20 | 10.30 | 10.25 | 10.22 |
| content percent by | | | | | | | |
| mass | | | | | | | |
| Cyantraniliprole | 80 | 98.70 | 97.80 | 98.60 | 98.70 | 98.50 | 98.00 |
| suspensibility | | | | | | | |
| percent min. | | | | | | | |
| pH range (1% aq. | 5.0 to 7.5 | 6.00 | 6.15 | 6.00 | 6.10 | 6.15 | 6.20 |
| Suspension) | | | | | | | |
| Pourability | 95% min. | 99.20 | 98.80 | 99.00 | 99.20 | 99.00 | 98.80 |
| Viscosity at | 350-800 cps | 600 | 610 | 605 | 610 | 615 | 620 |
| spindle no. 62, 20 | | | | | | | |
| rpm | | | | | | | |
| Particle size | D50 < 3, | 2.2, | 2.4, | 2.5, | 2.2, | 2.4, | 2.5, |
| (micron) | D90 < 10 | 8.5 | 8.6 | 8.8 | 8.5 | 8.6 | 8.8 |
| Persistent foam ml | 60 | Nil | 2 | Nil | Nil | 2 | nil |
| (after 1 minute) | | | | | | | |
| max. | | | | | | | |
| Spreading | Min 20 mm. | 35 | 33 | 34 | 35 | 35 | 34.6 |
| diameter (1% | | | | | | | |
| solution) | | | | | | | |

The novel OD formulation recipe of Cyantraniliprole 10.26% OD (Recipe A) meets the all inhouse specifications for storage stability studies in laboratory (at 54±2° C. & At 0±2° C. for 14 days) and room temperature (for 12 months).

Storage stability of conventional recipe of Cyantraniliprole
10.26% OD (Recipe-Prior art OD)

| | | | Laboratory | | | | |
|---|---|---|---|---|---|---|---|
| | | | storage for | | | | |
| | | | 14 days | | Room temperature | | |
| | | | At | At | storage | | |
| | Specification | | 54 ± 2° | 0 ± 2° | 1 | 6 | 12 |
| Parameters | (in house) | Initial | C. | C. | month | months | months |
| Cyantraniliprole | 9.50 to 10.50 | 10.40 | 10.10 | 10.20 | 10.30 | 10.22 | 10.10 |
| content percent by mass | | | | | | | |
| Cyantraniliprole | 80 | 98.70 | 97.80 | 98.60 | 98.70 | 97.80 | 97.00 |
| suspensibility percent | | | | | | | |
| min. | | | | | | | |
| pH range (1% aq. | 5.0 to 7.5 | 6.00 | 6.15 | 6.00 | 6.10 | 6.20 | 6.30 |
| Suspension) | | | | | | | |
| Pourability | 95% min. | 95.20 | 95.80 | 94.00 | 95.20 | 95.00 | 93.80 |
| Viscosity at spindle no. | 350-800 cps | 650 | 690 | 730 | 680 | 700 | 760 |
| 62, 20 rpm | | | | | | | |
| Particle size (micron) | D50 < 3, | 2.2, | 2.5, | 2.4, | 2.2, | 2.4, | 2.5, |
| | D90 < 10 | 8.6 | 10.2 | 9.6 | 8.6 | 9.5 | 10.4 |
| Persistent foam ml | 60 | Nil | 2 | nil | nil | 2 | nil |
| (after 1 minute) max. | | | | | | | |
| Spreading diameter | Min 20 mm. | 12 | 11 | 12 | 12 | 11 | 10.4 |
| (1% solution) | | | | | | | |

Storage stability of Cyantraniliprole 10.26% OD (Recipe-Prior art OD) Benevia shows poor pourability (93.8%), increase in particle size (1D90, 10.4) at 12 months of room storage and also has lower spreading properties.

### Example 8: Storage Stability Studies of Novel OD Formulations Recipes Vs Prior Art OD Formulations Recipe of Spirotetramat

Storage stability of novel OD formulation recipe
of Spirotetramat 15.31% w/w OD (Recipe-C-SPTMT)

| | | | Laboratory | | | | |
|---|---|---|---|---|---|---|---|
| | | | storage for | | | | |
| | | | 14 days | | Room temperature | | |
| | | | At | At | storage | | |
| | Specification | | 54 ± 2° | 0 ± 2° | 1 | 6 | 12 |
| Parameters | (in house) | Initial | C. | C. | month | months | months |
| Spirotetramat content | 14.73 to | 15.20 | 15.10 | 15.18 | 15.18 | 15.12 | 15.10 |
| percent by mass | 16.2855 | | | | | | |
| Spirotetramat | 80 | 98.60 | 98.00 | 98.20 | 98.40 | 98.30 | 98.00 |
| suspensibility percent | | | | | | | |
| min. | | | | | | | |
| pH range (1% aq. | 5.0 to 7.5 | 6.20 | 6.00 | 6.20 | 6.20 | 6.10 | 6.00 |
| Suspension) | | | | | | | |
| Pourability | 95% min. | 98.80 | 98.00 | 98.50 | 98.70 | 98.50 | 98.00 |
| Viscosity at spindle no. | 350-800 cps | 590 | 600 | 595 | 605 | 610 | 615 |
| 62, 20 rpm | | | | | | | |
| Particle size (micron) | D50 < 3, | 2.1, | 2.3, | 2.4, | 2.1, | 2.2, | 2.3, |
| | D90 < 10 | 8.4 | 8.5 | 8.7 | 8.6 | 8.7 | 8.9 |
| Persistent foam ml | 60 | Nil | 3 | nil | Nil | 3 | 3 |
| (after 1 minute) max. | | | | | | | |
| Spreading diameter (1% | Min 20 mm. | 32.2 | 30.4 | 31 | 32.4 | 31.2 | 30.8 |
| solution) | | | | | | | |

The novel OD formulation recipe of Spirotetramat 15.31% w/w OD (Recipe-C-SPTMT) meets the all inhouse specifications for storage stability studies in laboratory (at 54±2° C. & At 0±2° C. for 14 days) and room temperature (for 12 months).

Storage stability of conventional OD formulation of
Spirotetramat 15.31% w/w OD (Recipe-Prior art OD)

| | | | Laboratory | | | | |
|---|---|---|---|---|---|---|---|
| | | | storage for 14 | | | | |
| | | | days | | | | |
| | | | At | At | Room temperature storage | | |
| | Specification | | 54 ± 2° | 0 ± 2° | 1 | 6 | 12 |
| Parameters | (in house) | Initial | C. | C. | month | months | months |
| Spirotetramat content | 14.73 to | 15.20 | 15.05 | 15.12 | 15.18 | 15.10 | 15.04 |
| percent by mass | 16.2855 | | | | | | |
| Spirotetramat | 80 | 98.60 | 97.50 | 98.00 | 98.20 | 97.80 | 97.40 |
| suspensibility percent | | | | | | | |
| min. | | | | | | | |
| pH range (1% aq. | 5.0 to 7.5 | 6.20 | 6.00 | 6.20 | 6.10 | 6.00 | 5.90 |
| Suspension) | | | | | | | |
| Pourability | 95% min. | 95.80 | 95.20 | 95.00 | 95.20 | 94.20 | 92.40 |
| Viscosity at spindle | 350-800 | 660 | 700 | 750 | 700 | 760 | 800 |
| no. 62, 20 rpm | cps | | | | | | |
| Particle size (micron) | D50 < 3, | 2.2, | 2.5, | 2.3, | 2.2, | 2.3, | 2.8, |
| | D90 < 10 | 8.5 | 8.8 | 8.6 | 8.7 | 8.8 | 9.5 |
| Persistent foam ml | 60 | 2 | 6 | 3 | 5 | 10 | 18 |
| (after 1 minute) max. | | | | | | | |
| Spreading diameter | Min 20 | 9.6 | 10.4 | 8.9 | 9.2 | 8.6 | 6.8 |
| (1% solution) | mm. | | | | | | |

Storage stability of Spirotetramat 15.3100 w/w OD (Recipe-Prior art OD) shows poor pourability (94.20% at 6 months and 92.40% at 12 months) and also has lower spreading properties.

### Example 9: Storage Stability Studies of Novel OD Formulations Recipes Vs Prior Art OD Formulations Recipe of Penoxsulam+Cyhalofop-Butyl

Storage stability of novel OD formulation of Penoxsulam
1.02% + Cyhalofop-butyl 5.1% w/w OD (Recipe-C-PC)

| | | | Laboratory | | | | |
|---|---|---|---|---|---|---|---|
| | | | storage for 14 | | | | |
| | | | days | | Room temperature | | |
| | Specification | | At | At | storage | | |
| | (in | | 54 ± 2° | 0 ± 2° | 1 | 6 | 12 |
| Parameters | house) | Initial | C. | C. | month | months | months |
| Penoxsulam content | 0.969 to | 1.08 | 1.04 | 1.06 | 1.08 | 1.06 | 1.04 |
| percent by mass | 1.122 | | | | | | |
| Cyahlofop-butyl content | 4.845 to | 5.40 | 5.20 | 5.30 | 5.30 | 5.22 | 5.20 |
| percent by mass | 5.61 | | | | | | |
| Penoxsulam | 80 | 97.80 | 97.00 | 97.40 | 97.80 | 97.40 | 97.20 |
| suspensibility percent | | | | | | | |
| min. | | | | | | | |
| Cyahalofop-butyl | 80 | 97.20 | 96.00 | 97.00 | 97.20 | 97.00 | 97.20 |
| suspensibility percent | | | | | | | |
| min. | | | | | | | |
| pH range (1% aq. | 5.0 to | 6.50 | 6.30 | 6.50 | 6.50 | 6.40 | 6.30 |
| Suspension) | 7.5 | | | | | | |
| Pourability | 95% | 98.50 | 98.00 | 98.30 | 98.50 | 98.30 | 98.10 |
| | min. | | | | | | |
| Viscosity at spindle no. | 350-800 | 600 | 620 | 610 | 600 | 605 | 610 |
| 62, 20 rpm | cps | | | | | | |
| Particle size (micron) | D50 < 3, | 2.2, | 2.4, | 2.3, | 2.2, | 2.2, | 2.3, |
| | D90 < 10 | 8.2 | 8.4 | 8.3 | 8.2 | 8.3 | 8.3 |
| Persistent foam ml (after | 60 | Nil | 2 | nil | Nil | nil | 2 |
| 1 minute) max. | | | | | | | |
| Spreading diameter (1% | Min 20 | 38.4 | 34.6 | 37.6 | 38.3 | 38 | 37.2 |
| solution) | mm. | | | | | | |

The novel OD formulation recipe of Storage stability-Penoxsulam 1.02%+Cyhalofop-butyl 5.1% w/w OD (Recipe-C-PC) meets the all inhouse specifications for storage stability studies in laboratory (at 54±2° C. & At 0±2° C. for 14 days) and room temperature (for 12 months).

Storage stability of conventional OD formulation of Penoxsulam
1.02% + Cyhalofop-butyl 5.1% w/w OD (Prior art Recipe-PC)

| | | | Laboratory | | | | |
|---|---|---|---|---|---|---|---|
| | | | storage for 14 | | | | |
| | | | days | | Room temperature | | |
| | | | At | At | storage | | |
| | Specification | | 54 ± 2° | 0 ± 2° | 1 | 6 | 12 |
| Parameters | (in house) | Initial | C. | C. | month | months | months |
| Penoxsulam content | 0.969 to | 1.08 | 1.02 | 1.05 | 1.07 | 1.04 | 1.02 |
| percent by mass | 1.122 | | | | | | |
| Cyahlofop-butyl | 4.845 to 5.61 | 5.40 | 5.12 | 5.24 | 5.35 | 5.24 | 5.10 |
| content percent by | | | | | | | |
| mass | | | | | | | |
| Penoxsulam | 80 | 95.40 | 94.60 | 95.30 | 95.20 | 94.60 | 94.00 |
| suspensibility | | | | | | | |
| percent min. | | | | | | | |
| Cyahalofop-butyl | 80 | 95.00 | 94.20 | 94.70 | 94.80 | 94.20 | 93.40 |
| suspensibility | | | | | | | |
| percent min. | | | | | | | |
| pH range (1% aq. | 5.0 to 7.5 | 6.40 | 6.20 | 6.30 | 6.40 | 6.30 | 6.20 |
| Suspension) | | | | | | | |
| Pourability | 95% min. | 95.80 | 95.20 | 95.60 | 95.30 | 94.20 | 93.20 |
| Viscosity at spindle | 350-800 cps | 590 | 660 | 630 | 620 | 690 | 740 |
| no. 62, 20 rpm | | | | | | | |
| Particle size | D50 < 3, | 2.2, | 2.6, | 2.4, | 2.3, | 2.5, | 2.7, |
| (micron) | D90 < 10 | 8.2 | 8.8 | 8.5 | 8.3 | 8.6 | 8.9 |
| Persistent foam ml | 60 | 8 | 3 | 4 | 6 | 8 | 10 |
| (after 1 minute) max. | | | | | | | |
| Spreading diameter | Min 20 mm. | 6.8 | 5.2 | 6.4 | 6 | 5.2 | 4.4 |
| (1% solution) | | | | | | | |

The storage stability of Penoxsulam 1.020%+Cyhalofop-butyl 5.100 w/w OD (Prior art recipe-PC) does not meets pourability (9500 min.) and spreading diameter (10% solution) criteria.

### Example 10: Storage Stability Studies of Novel OD Formulations Recipes Vs Prior Art OD Formulations Recipe of Prothioconazole

Storage stability of novel OD formulation recipe
of Prothioconazole 20% OD (Recipe C-PRT20)

| | | | Laboratory | | | | |
|---|---|---|---|---|---|---|---|
| | | | storage for | | | | |
| | | | 14 days | | Room temperature | | |
| | | | At | At | storage | | |
| | Specification | | 54 ± 2° | 0 ± 2° | 1 | 6 | 12 |
| Parameters | (in house) | Initial | C. | C. | month | months | months |
| Prothioconazole content | 19.00 to | 20.80 | 20.30 | 20.70 | 20.80 | 20.60 | 20.50 |
| percent by mass | 21.00 | | | | | | |
| Prothioconazole | 80 | 98.20 | 97.80 | 98.00 | 98.10 | 97.80 | 97.40 |
| suspensibility percent | | | | | | | |
| min. | | | | | | | |
| pH range (1% aq. | 5.0 to 7.5 | 6.00 | 5.90 | 6.00 | 6.00 | 6.00 | 6.00 |
| Suspension) | | | | | | | |
| Pourability | 95% min. | 97.80 | 97.20 | 97.60 | 97.80 | 97.60 | 97.40 |
| Viscosity at spindle no. | 350-800 cps | 580 | 590 | 580 | 580 | 590 | 590 |
| 62, 20 rpm | | | | | | | |
| Particle size (micron) | D50 < 3, | 2.1, | 2.2, | 2.1, | 2.1, | 2.2, | 2.2, |
| | D90 < 10 | 8.2 | 8.3 | 8.2 | 8.2 | 8.3 | 8.3 |
| Persistent foam ml | 60 | nil | 2.5 | nil | Nil | 1.5 | 2 |
| (after 1 minute) max. | | | | | | | |
| Spreading diameter | Min 20 mm. | 38.2 | 36.8 | 37.8 | 38.2 | 37.8 | 36.5 |
| (1% solution) | | | | | | | |

The novel OD formulation recipe of Storage stability—Prothioconazole 2000 OD (Recipe C-PRT20) meets the all inhouse specifications for storage stability studies in laboratory (at 54±2° C. & At 0±2° C. for 14 days) and room temperature (for 12 months).

Storage stability of conventional OD formulation
of Prothioconazole 20% OD (Recipe-Prior art OD)

| | | | Laboratory | | | | |
|---|---|---|---|---|---|---|---|
| | | | storage for 14 | | | | |
| | | | days | | Room temperature | | |
| | | | At | At | storage | | |
| | Specification | | 54 ± 2° | 0 ± 2° | 1 | 6 | 12 |
| Parameters | (in house) | Initial | C. | C. | month | months | months |
| Prothioconazole | 19.00 to 21.00 | 20.80 | 20.20 | 20.60 | 20.60 | 20.40 | 20.20 |
| content percent by | | | | | | | |
| mass | | | | | | | |
| Prothioconazole | 80 | 95.40 | 94.20 | 95.20 | 95.20 | 95.00 | 94.60 |
| suspensibility | | | | | | | |
| percent min. | | | | | | | |
| pH range (1% aq. | 5.0 to 7.5 | 5.80 | 5.40 | 5.70 | 5.70 | 5.50 | 5.40 |
| Suspension) | | | | | | | |
| Pourability | 95% min. | 95.80 | 95.00 | 95.40 | 95.20 | 94.50 | 93.80 |
| Viscosity at | 350-800 cps | 620 | 680 | 640 | 640 | 700 | 800 |
| spindle no. 62, 20 | | | | | | | |
| rpm | | | | | | | |
| Particle size | D50 < 3, | 2.3, | 2.8, | 2.5, | 2.4, | 2.5, | 2.9, |
| (micron) | D90 < 10 | 8.3 | 9.2 | 8.8 | 8.6 | 8.7 | 9.6 |
| Persistent foam ml | 60 | 5 | 10 | 7.5 | 6 | 8.5 | 11.6 |
| (after 1 minute) | | | | | | | |
| max. | | | | | | | |
| Spreading | Min 20 mm. | 8.2 | 5.4 | 6.5 | 7.4 | 6.2 | 5.2 |
| diameter (1% | | | | | | | |
| solution) | | | | | | | |

The storage stability of Prothioconazole 20% OD (Recipe-Prior art OD) does not meets pourability (95% min.) and spreading diameter (1% solution) criteria.

### Field Bio-Efficacy Studies:

The recipe of novel OD (Oil Dispersion) formulation of different insecticides and herbicides were developed in the laboratory and studied in the laboratory and field for their benefits over prior art OD formulations.

The major objectives of studies are.
To study the bio efficacy of novel recipe of OD formulation vs prior art OD formulations
To study the residual control obtained by novel OD formulations vs prior art formulations
To study the impact of spray volume
To study the rain fast properties of novel recipe of OD formulations.

### Experiment 1: To Study the Bio-Efficacy and Residual Control Provided by Novel Recipe of OD Formulations Against Cabbage Diamond Back Moth.

Crop: Cabbage
Insects: Diamond back moth (DBM), Plutella xylostella
Location: Padra, Dist. Baroda, Gujarat
Treatments: 9
Plot size: 30 sq.m.
Crop age: 48 days after transplanting. Average 8 to 10 larvae per plant.
Spray water volume: 400 liter per hectare
Method of Application: Foliar spray with battery operated knapsack sprayer fitted with hollow cone nozzle.
Agronomic Practices: Except insecticidal applications, all agronomic practices followed as per the crop requirement.
Observation Methods: Diamond back moth (DBM, Plutella xylostella) larval control (%):
10 plants per plot were selected randomly to count the number of live larvae per plant.
Calculate % DBM larval control. Record the observations on 1, 3, 7, 10, 14 and 18 days after spraying.

$$\% Larval control = 100 - \frac{Number of live larva in treated plot}{Number of live larvae in untreated control} \times 100$$

TABLE 1
Control of DBM larvae on cabbage

| | Treatment details with | % Larval control, DBM | | | | | |
|---|---|---|---|---|---|---|---|
| Treatment | application Rate | 1 | 3 | 7 | 10 | 14 | 18 |
| Number | (ml or g per Hectare) | DAA | DAA | DAA | DAA | DAA | DAA |
| T1 | Cyantraniliprole 10.26% OD | 99.8 | 97.2 | 92.6 | 87.2 | 71.2 | 56.2 |
| | (Recipe A)-100 ml | | | | | | |
| T2 | Cyantraniliprole 10.26% OD | 99.4 | 97.8 | 93.4 | 88.4 | 72.4 | 57.4 |
| | (Recipe B)-100 ml | | | | | | |
| T3 | Cyantraniliprole 10.26% OD | 99.6 | 97.2 | 93.4 | 88.2 | 71.6 | 55.8 |
| | (Recipe C)-100 ml | | | | | | |
| T4 | Cyantraniliprole 10.26% OD | 99.4 | 97.6 | 92.6 | 87.6 | 72.2 | 54.2 |
| | (Recipe D)-100 ml | | | | | | |
| T5 | Cyantraniliprole 10.26% OD | 99.2 | 97.2 | 92.8 | 87.4 | 73.0 | 55.6 |
| | (Recipe E)-100 ml | | | | | | |
| T6 | Cyantraniliprole 10.26% OD | 99.0 | 97.4 | 94.2 | 88.0 | 72.4 | 54.6 |
| | (Recipe F)-100 ml | | | | | | |
| T7 | Cyantraniliprole 10.26% OD | 98.8 | 94.2 | 87.6 | 77.2 | 56.4 | 36.2 |
| | (Recipe-Prior art OD)-100 | | | | | | |
| | ml | | | | | | |
| T8 | Cyantraniliprole 20% SC | 98.6 | 91.0 | 81.8 | 70.4 | 48.2 | 24.8 |
| | (Recipe-Prior art SC)-50 ml | | | | | | |
| T9 | UTC (Untreated Check) | 0.0 | 0.0 | 0.0 | 0.0 | 0.0 | 0.0 |

All the novel OD formulation recipe of Cyantraniliprole 10.26% OD i.e. T1 to T6, provides excellent control of DBM larvae on cabbage crop (i.e. >920% larval control up to 7^{th} DAA, >870% larval control on 10^{th} DAA, >710% larval control on 14^{th} DAA and >54% larval control on 18^{th} DAA) in comparison to prior art OD formulation T7 (i.e. 870%, 7700 560% and 3600 larval control on 7^{th}, 10^{th}, 14^{th} and 18^{th} DAA respectively) and prior art SC formulation T8 (i.e. 81%, 70%, 48% and 24% larval control on 7^{th}, 10^{th}, 14^{th} and 18^{th} day DAA respectively).

TABLE 2
Increase in larval control due to novel recipe of OD formulations

| | | % increase in larval control over T7 (Recipe- | | | | | |
|---|---|---|---|---|---|---|---|
| | Treatment details with | prior art OD) | | | | | |
| Treatment | application Rate (ml or g per | 1 | 3 | 7 | 10 | 14 | 18 |
| Number | Hectare) | DAA | DAA | DAA | DAA | DAA | DAA |
| T1 | Cyantraniliprole 10.26% OD | 1.0 | 3.2 | 5.7 | 13.0 | 26.2 | 55.2 |
| | (Recipe A)-100 ml | | | | | | |
| T2 | Cyantraniliprole 10.26% OD | 0.6 | 3.8 | 6.6 | 14.5 | 28.4 | 58.6 |
| | (Recipe B)-100 ml | | | | | | |
| T3 | Cyantraniliprole 10.26% OD | 0.8 | 3.2 | 6.6 | 14.2 | 27.0 | 54.1 |
| | (Recipe C)-100 ml | | | | | | |
| T4 | Cyantraniliprole 10.26% OD | 0.6 | 3.6 | 5.7 | 13.5 | 28.0 | 49.7 |
| | (Recipe D)-100 ml | | | | | | |
| T5 | Cyantraniliprole 10.26% OD | 0.4 | 3.2 | 5.9 | 13.2 | 29.4 | 53.6 |
| | (Recipe E)-100 ml | | | | | | |
| T6 | Cyantraniliprole 10.26% OD | 0.2 | 3.4 | 7.5 | 14.0 | 28.4 | 50.8 |
| | (Recipe F)-100 ml | | | | | | |
| T7 | Cyantraniliprole 10.26% OD | 0 | 0 | 0 | 0 | 0 | 0 |
| | (Recipe-Prior art OD)-100 | | | | | | |
| | ml | | | | | | |
| T8 | Cyantraniliprole 20% SC | — | — | — | — | — | — |
| | (Recipe-Prior art SC)-50 ml | | | | | | |
| T9 | UTC (Untreated Check) | — | — | — | — | — | — |

All the novel recipe of OD formulations of cyantraniliprole 10.26% OD (T1 to T6) on an average provides minimum 5.7% higher control of DBM larvae on 7^{th} DAA, 13% on 10^{th} DAA, 26% on 14^{th} DAA and 49% higher control of DBM larvae on 18^{th} DAA.

### Experiment 2: To Study the Impact of Different Dosages on Bio-Efficacy and Residual Control Provided by Novel Recipe of OD Formulations Against Sucking Pests Infesting Cotton Crop

Crop: Cotton
Insects: Jassid (Amrasca biguttula bigutulla), Thirps (Thrips tabaci)
Location: Karjan, Dist. Baroda, Gujarat
Treatments: 13
Plot size: 40 sq.m.
Crop age: 55 days after sowing.
Spray water volume: 390 liter per hectare Method of Application: Foliar spray with battery operated knapsack sprayer fitted with hollow cone nozzle.
Agronomic Practices: Except insecticidal applications, all agronomic practices followed as per the crop requirement.
Observation Methods: Insect control (%)—Count the number of live insects (jassid and thrips separately) per leaf.
Record the observations from 3 leaves per plant and 10 plants per plot on 0 (Precount), 2 and 7 days after application (DAA).
Calculate % insect control by below formula.

$$\% Insect control = 100 - \frac{\begin{matrix}Number of live insects \\ in treatment\end{matrix}}{\begin{matrix}Number of live insects \\ in untreated\end{matrix}} \times 100$$

TABLE 3
Control of sucking pests in cotton crop

| | | % Insect control | | | | | |
|---|---|---|---|---|---|---|---|
| | | Jassid | | | Thrips | | |
| | | Precount | | | Precount | | |
| Treatment | Treatment details with application | (Per | 2 | 7 | (Per | 2 | 7 |
| Number | Rate (ml or g per Hectare) | leaf) | DAA | DAA | leaf) | DAA | DAA |
| T1 | Spirotetramat 15.31% w/w OD (Recipe-A-SPTMT)-400 | 6.43 | 96.2 | 70.2 | 10.24 | 90.2 | 68.8 |
| | ml | | | | | | |
| T2 | Spirotetramat 15.31% w/w OD (Recipe-B-SPTMT)-400 | 6.27 | 95.8 | 68.8 | 9.86 | 91.6 | 69.4 |
| | ml | | | | | | |
| T3 | Spirotetramat 15.31% w/w OD (Recipe-C-SPTMT)-400 | 6.88 | 96.4 | 69.4 | 11.26 | 91.4 | 70.4 |
| | ml | | | | | | |
| T4 | Spirotetramat 15.31% w/w OD (Recipe-D-SPTMT)-400 | 6.57 | 97.2 | 68.6 | 12.64 | 90.2 | 69.6 |
| | ml | | | | | | |
| T5 | Spirotetramat 15.31% w/w OD (Recipe-Prior art OD)- | 6.45 | 92.4 | 54.2 | 13.26 | 87.4 | 58.4 |
| | 400 ml | | | | | | |
| T6 | Spirotetramat 24% SC (Recipe-Prior art SC)-400 ml | 6.32 | 90.8 | 45.6 | 10.97 | 85.2 | 52.4 |
| T7 | Spirotetramat 15.31% w/w OD (Recipe-A-SPTMT)-300 | 6.80 | 89.6 | 58.2 | 9.28 | 84.2 | 58.4 |
| | ml | | | | | | |
| T8 | Spirotetramat 15.31% w/w OD (Recipe-B-SPTMT)-300 | 6.67 | 88.8 | 56.2 | 11.46 | 83.8 | 59.2 |
| | ml | | | | | | |
| T9 | Spirotetramat 15.31% w/w OD (Recipe-C-SPTMT)-300 | 6.42 | 88.8 | 56.2 | 10.63 | 85.2 | 58.6 |
| | ml | | | | | | |
| T10 | Spirotetramat 15.31% w/w OD (Recipe-D-SPTMT)-300 | 6.56 | 89.8 | 54.2 | 11.24 | 83.6 | 59.0 |
| | ml | | | | | | |
| T11 | Spirotetramat 15.31% w/w OD (Recipe-Prior art OD)- | 6.29 | 77.2 | 30.4 | 10.75 | 76.4 | 36.6 |
| | 300 ml | | | | | | |
| T12 | Spirotetramat 24% SC (Recipe-Prior art SC)-300 ml | 6.44 | 75.2 | 23.4 | 11.03 | 72.4 | 30.4 |
| T13 | UTC (Untreated Check) | 6.58 | 0.0 | 0.0 | 10.95 | 0.0 | 0.0 |

TABLE 4
Reduction in sucking pests control due to dose reduction.

| Dose reduction | Reduction in % insect control due to dose reduction | | | |
|---|---|---|---|---|
| from 400 ml/h | Jassid | | Thrips | |
| to 300 ml/h | 2 DAA | 7 DAA | 2 DAA | 7 DAA |
| T1-T7 | 6.6 | 12 | 6.0 | 10.4 |
| T2-T8 | 7.0 | 12.6 | 7.8 | 10.2 |
| T3-T9 | 7.6 | 13.2 | 6.2 | 11.8 |
| T4-T10 | 7.4 | 14.4 | 6.6 | 10.6 |
| T5-T11 | 15.2 | 23.8 | 11.0 | 21.8 |
| T6-T12 | 15.6 | 22.2 | 12.8 | 22.0 |

The field trial results shows that bio efficacy and residual control obtained by novel recipes of OD formulations does not much affected by lowering the dosages. At DAA, the dosage of 400 ml/h of novel recipes of Spirotetramat i.e., Ti, T2, T3 and T4 provides 96.2%, 95.800, 96.400 and 97.2% control of jassid respectively and the dosages of 300 ml/h of novel recipes of Spirotetramat i.e., T7, T8, T9 and T1O provides 89.6%, 88.8%, 88.8% and 89.8% control of jassid respectively (Table 3). So approximately, 6.6%, 70&, 7.6% and 7.4% jassid control reduce in treatment of T1, T2, T3 and T4 respectively when the dosages reduce from 400 ml/h to 300 ml/h (Table 4). In contrast, jassid control reduced by 15.2% and 15.6% in treatment T5 and T6 respectively when dosages reduce from 400 ml/h to 300 ml/h in prior art treatment (T5 and T6, Table 4). The similar trend were observed on 7 DAA for jassid control and thrips control on 2 DAA and 7 DAA (Table 4). We can say that novel recipes of OD formulations of spirotetramat provides better control of sucking pests in comparison with prior art OD formulation and SC formulation at 25% (from 400 ml/h to 300 ml/h) dose reduction.

### Experiment 3: To Study the Impact of Novel Recipe of OD Formulation on Synergistic Control of Chilly Thrips

Crop: Chilly
Insects: Thirps (Scirtothrips dorsalis)
Location: Umreth, Dist. Anand, Gujarat
Treatments: 8
Plot size: 30 sq.m.
Crop age: 52 days after transplanting.
Spray water volume: 375 liter per hectare
Method of Application: Foliar spray with battery operated knapsack sprayer fitted with hollow cone nozzle.
Agronomic Practices: Except insecticidal applications, all agronomic practices followed as per the crop requirement.
Observation Methods:
Thrips control (%)—Count the number of live thrips (insects) per twig by shaking the twigs over black color piece of paper. Record the observations from 5 twigs per plant and 10 plants per plot on 0 (Precount), 3, 7 and 10 days after application (DAA).
Calculate % insect control by below formula.

$$\% Insect control = 100 - \frac{\begin{matrix}Number of live insect \\ in treatment\end{matrix}}{\begin{matrix}Number of live insects \\ in untreated\end{matrix}} \times 100$$

To calculate synergism apply below formula to insect control (%) data.

Colby's formula for calculating synergism between two active ingredients

$$E = X + Y - \frac{XY}{100}$$

Where, E=Expected % control by mixture or ready mix combination of Compound A and Compound Binna defined dose
   X=Observed % control by Compound A
   Y=Observed % control by Compound B

$$Ratio = \frac{Observed value ( \% control )}{Expected value ( \% control )}$$

Ratio of O/E>1, means synergism observed. Higher the value of ratio means stronger the synergism.

TABLE 5
Treatment details

| Treatment | Treatment details with application | |
|---|---|---|
| Number | Rate (ml per Hectare) | gai/h |
| T1 | Betacyfluthrin 8.49% w/w + Imidacloprid | 18 + 42 |
| | 19.81% w/w OD (Recipe A-BI) | |
| T2 | Betacyfluthrin 8.49% w/w + Imidacloprid | 18 + 42 |
| | 19.81% w/w OD (Recipe B-BI) | |
| T3 | Betacyfluthrin 8.49% w/w + Imidacloprid | 18 + 42 |
| | 19.81% w/w OD (Recipe C-BI) | |
| T4 | Betacyfluthrin 8.49% w/w + Imidacloprid | 18 + 42 |
| | 19.81% w/w OD (Prior art recipe-BI) | |
| T5 | Betacyfluthrin 2.45% w/w SC + Imidacloprid | 18 + 42 |
| | 17.8% SL (tank-mix prior art) | |
| T6 | Betacyfluthrin 2.45% w/w SC | 18 |
| T7 | Imidacloprid 17.8% SL | 42 |
| T8 | UTC (Untreated Check) | |

TABLE 6
Synergistic control of Chilly thrips

| | % Thrips control | | | | | | |
|---|---|---|---|---|---|---|---|
| | 1 DAA | | | | | | |
| Treatment | Obs. | Cal. | Colby's | Synergism | | | |
| Number | Value | Value | ratio | (Y/N) | 3 DAA | 7 DAA | 10 DAA |
| T1 | 94.2 | 78.37 | 1.20 | Y (strong) | 89.40 | 78.80 | 56.80 |
| T2 | 95.4 | 78.37 | 1.22 | Y (strong) | 88.40 | 79.40 | 57.20 |
| T3 | 94.6 | 78.37 | 1.21 | Y (strong) | 88.60 | 78.20 | 55.20 |
| T4 | 83.2 | 78.37 | 1.06 | Y (weak) | 77.40 | 62.20 | 45.20 |
| T5 | 80.6 | 78.37 | 1.03 | Y (weak) | 74.60 | 61.20 | 44.40 |
| T6 | 56.4 | | | | 52.40 | 40.20 | 30.40 |
| T7 | 50.4 | | | | 46.60 | 35.80 | 21.60 |
| T8 | 0.0 | | | | 0.0 | 0 | 0 |

The field trials results shows that novel recipes of OD formulation of betacyfluthrin+imidacloprid (T1, T2, T3) provides very strong (colby's ratio >1.20) synergistic control of chilly thrips in comparison to prior art OD formulations (T4, colby's ratio 1.06) and tank mix Beacyfluthrin 2.45% w/w SC-720 ml+Imidacloprid 17.8% (20% w/w) SL-210 ml (T5, Colby's ratio 1.03). The novel recipe of OD formulation of betacyfluthrin+imidacloprid also provides longer residual control with strong synergism.

### Experiment 4: To Study the Impact of Spray Volume on Bio Efficacy of Novel Recipe of OD Formulation

Crop: Paddy (direct seeded rice-DSR)
Weeds: Mixed weed flora (Grasses, Broad Leaf weeds & Sedges)
Location: Rajim, Chattisgarh
Treatments: 9
Plot size: 30 sq.m.
Application Time: 12 days after sowing
Spray water volume: as given in treatment details
Method of Application: Foliar spray with battery operated knapsack sprayer fitted with flat fan nozzle.
Agronomic Practices: Except weed control, all agronomic practices followed as per the crop requirement.
Observation Methods:
Weed control (%): Count the number of weeds from 50×50 cm spot. Record the species wise count (grassy weeds, broadleaf weeds & sedges) from 5 spots per plot on₁₅ₜh days after application (15 DAA). Calculate weed control efficiency by below formula.

$$\% Weed control efficiency = 100 - \frac{\begin{matrix}Average number of \\ weeds in treatment\end{matrix}}{\begin{matrix}Average number of \\ weeds in untreated \\ control ( UTC )\end{matrix}} \times 100$$

Calculate synergism by using formula given in Experiment 3.

TABLE 7
Treatment details
Treatment details with application Rate (ml or g per Hectare)

T1-Penoxsulam 1.02% + Cyhalofop-butyl 5.1% w/w OD (Recipe-A-PC)-2000 ml/400 l
water
T2-Penoxsulam 1.02% + Cyhalofop-butyl 5.1% w/w OD (Recipe-B-PC)-2000 ml/400 l
water
T3-Penoxsulam 1.02% + Cyhalofop-butyl 5.1% w/w OD (Recipe-C-PC)-2000 ml/400 l
water
T4-Penoxsulam 1.02% + Cyhalofop-butyl 5.1% w/w OD (Prior art recipe-PC)-2000 ml/400
l water
T5-Penoxsulam 1.02% + Cyhalofop-butyl 5.1% w/w OD (Recipe-A-PC)-2000 ml/300 l
water
T6-Penoxsulam 1.02% + Cyhalofop-butyl 5.1% w/w OD (Recipe-B-PC)-2000 ml/300 l
water
T7-Penoxsulam 1.02% + Cyhalofop-butyl 5.1% w/w OD (Recipe-C-PC)-2000 ml/300 l
water
T8-Penoxsulam 1.02% + Cyhalofop-butyl 5.1% w/w OD (Prior art recipe-PC)-2000 ml/300
l water
T9-UTC (Untreated Check)

TABLE 8
Impact of spray volume on weed control efficiency in Paddy (DSR)

| | % Weed control at 15 DAA | | | | | |
|---|---|---|---|---|---|---|
| | | | | % Reduction in weed | | |
| | | | | control due to water | | |
| | | | | volume | | |
| | | Broad | | | Broad | |
| Treatment details with application Rate | Grassy | Leaf | | Grassy | Leaf | |
| (ml/Hectare) | Weeds | weed | Sedges | Weeds | weed | Sedges |
| T1-(Recipe-A-PC)-2000 ml/400 l water | 99.6 | 98.4 | 94.6 | | | |
| T2-(Recipe-B-PC)-2000 ml/400 l water | 99.2 | 98.2 | 93.8 | | | |
| T3-(Recipe-C-PC)-2000 ml/400 l water | 99.8 | 98.0 | 94.2 | | | |
| T4-(Prior art recipe-PC)-2000 ml/400 l water | 89.4 | 86.2 | 83.8 | | | |
| T5-(Recipe-A-PC)-2000 ml/300 l water | 97.6 | 97.2 | 92.4 | 2.01 | 1.22 | 2.33 |
| T6-(Recipe-B-PC)-2000 ml/300 l water | 98.0 | 96.8 | 91.6 | 1.21 | 1.43 | 2.35 |
| T7-(Recipe-C-PC)-2000 ml/300 l water | 98.2 | 97.0 | 91.4 | 1.60 | 1.02 | 2.97 |
| T8-(Prior art recipe-PC)-2000 ml/300 l water | 80.2 | 77.4 | 70.8 | 10.29 | 10.21 | 15.51 |
| T9-UTC (Untreated Check) | 0.00 | 0.0 | 0.0 | 0.00 | 0.0 | 0.0 |

The field trial results shows that weed control efficiency were not much reduce by lowering the spray volume in novel recipe (T1, T2, T3) of OD formulation (i.e. 2.01% in grassy weeds, 1.43% in broad leaf weeds and 2.33% in sedges). The weed control efficiency were drastically reduced (i.e. 10.29% in grassy weeds, 10.21% broad leaf weeds and 15.51% in sedges) when it was applied with lower spray volume with prior art treatment (T4). Phytotoxicity symptoms were observed in any of the treatments. The better efficacy of novel recipe of OD formulations of Penoxsulan+Cyhalofop butyl observed due to the combined effect of wetting-spreading-penetrating agent (Polyalkyleneoxide modified Heptamethyl trisiloxane) wetting-spreading-penetrating agent (Polyalkyleneoxide modified Heptamethyl trisiloxane) and carrier-solvent (Blend of Methyl ester of Pongamia oil and sunflower oil, Blend of Methyl ester of palm oil and sunflower oil, Blend of Methyl ester of Pongamia oil, palm oil and sunflower oil).

### Experiment 5: Study of Rain Fastness Properties of Novel Recipe of OD Formulations

Crop & Variety: Marigold, Lemon shade
Location: Umreth, Dist. Anand, Gujarat
Treatments: 9
Plot size: 40 sq.m.
Crop age ta 78 days after transplanting.
Spray water volume 500 liter per hectare
Method of Application: Foliar spray with battery operated knapsack sprayer fitted with hollow cone nozzle.
Agronomic Practices: Except fungicidal applications, all agronomic practices followed as per the crop requirement.
Methods for rain fastness study:

The treatment application (spraying) was done knap sack sprayer by using 500 liter spray volume. After 60 minutes of spraying, artificial raining was done through overhead sprinkler system in trial plot for 30 minutes which was approximately equal to 10 mm of rainfall (measured by rain gauge). The flower rot disease incidence (%) was recorded by counting the number of healthy and diseased flowers per plant and 5 plants per plot were observed. The observations on flower rot disease incidence were recorded at Pretreatment (0 days), 3, 7, 10 and 14 days after spraying. Count the number of healthy flowers from 5 plants on 14 DAA (days after application).

$$Flower rot incidence ( \% ) = \frac{number of diseased flowers}{\begin{matrix}total number of flowers \\ observed ( healthy + diseased )\end{matrix}} \times 100$$

TABLE 9
Treatment details

| | | | | | | Number |
|---|---|---|---|---|---|---|
| | | | | | | of |
| | | | | | | Healthy |
| | | | | | | flowers/ |
| | Flower rot disease incidence (%) | | | | | 5 plants |
| Treatment details with User Rate (gram | 0 | 3 | 7 | 10 | 14 | at 14 |
| active per Hectare) | DAA | DAA | DAA | DAA | DAA | DAA |
| T1-Prothioconazole 20% OD (Recipe A- | 5.18 | 3.70 | 0.82 | 1.16 | 2.58 | 62.46 |
| PRT20)-125 gai/h | | | | | | |
| T2-Prothioconazole 20% OD (Recipe B- | 5.82 | 3.64 | 0.76 | 1.20 | 2.48 | 61.22 |
| PRT20)-125 gai/h | | | | | | |
| T3-Prothioconazole 20% OD (Recipe C- | 5.32 | 3.72 | 0.68 | 1.12 | 2.64 | 61.96 |
| PRT20)-125 gai/h | | | | | | |
| T4-Prothioconazole 20% OD (Recipe D- | 5.26 | 3.68 | 0.84 | 1.18 | 2.52 | 60.38 |
| PRT20)-125 gai/h | | | | | | |
| T5-Prothioconazole 20% OD (Prior art)- | 5.74 | 3.88 | 2.82 | 3.86 | 5.24 | 56.84 |
| 125 gai/h | | | | | | |
| T6-Prothioconazole 40% SC-125 gai/h | 5.62 | 3.96 | 2.64 | 4.82 | 5.72 | 49.86 |
| T7-Prothioconazole 25% EC-125 gai/h | 5.84 | 3.92 | 2.26 | 4.46 | 6.14 | 47.28 |
| T8-Prothioconazole 80% WG-125 gai/h | 5.44 | 3.96 | 2.28 | 5.10 | 7.28 | 42.76 |
| T9-UTC (Untreated Check) | 5.72 | 7.86 | 10.84 | 14.62 | 20.84 | 24.68 |

All the novel recipe of OD formulations (T1, T2, T3 & T4) shows excellent rain fast action and as compared to prior art OD formulations (T5) and other prior art formulations (T6, T7, T8). All the novel recipe of OD formulations (T1, T2, and T3 & T4) also produces higher number of healthy flowers.

### SUMMARY AND CONCLUSION

Novel recipe of OD formulations provides higher efficacy compared to prior art OD formulation recipe, other prior art formulations (EC, SC, WG) and tank mixes.
Novel recipes of OD formulations provide better efficacy at reduced dosages in comparison with prior art OD formulation recipe. So, we can reduce the active ingredients application rate with novel recipes of OD formulations.
Novel recipes of OD formulations provide better efficacy at reduced spray volume in comparison with prior art OD formulation recipe. So novel recipe of OD formulation will be helpful to the farmers in water scarcity area.
Novel recipe of OD formulations shows excellent rain fast action. This is very useful during the rainy season.
Novel recipe of OD formulations observed safe to the crop and does not have any kind of phytotoxicity symptoms.

We claim:

1. An synergistic Oil Dispersion agrochemical formulation comprising:
a. an active ingredient or combination thereof suspended in an oil phase present in amount of 5%-80% by weight;
b. super wetting-spreading-penetrating agent present in amount of 1% to 10% by weight;
c. solvent selected from Pongamia oil or palm oil or jojoba oil or combination thereof or blend with vegetable oil in amount of 10% to 80% by weight; and
d. at least one formulation excipient.

2. The synergistic Oil Dispersion agrochemical formulation as claimed in claim 1, wherein active ingredient is compound selected from group of insecticide, fungicide, herbicide or plant health additives or combination thereof.

3. The synergistic Oil Dispersion agrochemical formulation as claimed in claim 1, wherein super wetting-spreading-penetrating agent is Polyalkyleneoxide modified Heptamethyl trisiloxane (Modified trisiloxane) present in an amount of 1% to 10% by weight.

4. The synergistic Oil Dispersion agrochemical formulation as claimed in claim 1, wherein oil phase as a carrier is selected from Pongamia oil; or palm oil; or Pongamia oil and palm oil; or Pongamia oil and jojoba oil; or palm oil and jojoba oil; or Pongamia oil and vegetable oil; or palm oil and vegetable oil; or Pongamia oil and palm oil and vegetable oil; or solvent; or both.

5. The synergistic Oil Dispersion agrochemical formulation as claimed in claim 3, wherein vegetable oil may be selected from one or mixture of two or more selected from soybean (Glycine max) oil, groundnut (Arachis hypogaea) oil, rapeseed (Brassica napus subspecies) oil, mustard (Brassica juncea) oil, sesame (Sesamum indicum) oil, Corn (Zea mays) oil, rice (Oryza sativa) bran oil, castor (Ricinum communis) seed oil, cotton (Gossypium hirsutum) seed oil, linseed (Linum usitatissimum), coconut (Cocos nucifera) oil, Kapok (Ceiba pentandra) oil, Papaya (Carica papaya) seed oil, Tea seed (Camellia oleifera) oil, sunflower (Helianthus annuus) oil, safflower (Carthamus tinctorius) seed oil, Eucalyptus (Eucalyptus globulus) oil, Olive (Olea europaea) oil, Jatropha (Jatropha curcas) oil, Garlic acid (Allium sativum), Ginger oil (Zingiber officinale), D-limonene, Citronella oil or Ceylon ironwood (Mesua ferrea) oil, Mahua (Madhuca longifolia) oil.

6. The synergistic Oil Dispersion agrochemical formulation as claimed in claim 3, wherein solvent for the present formulation, the Pongamia oil, palm oil, or their blend with vegetable oil and their mixtures may be alkylated or ethoxylated or epoxylated or esterified.

7. The synergistic Oil Dispersion agrochemical formulation as claimed in claim 1, wherein formulation excipient is selected from emulsifying agent, dispersing agent, stabilizers, antifoaming agent, preservative, anti-freezing agent, buffering agent.

8. The synergistic Oil Dispersion agrochemical formulation as claimed in claim 7, wherein Emulsifying agent is selected from castor oil ethoxylates, alcohol ethoxylates, fatty acid ethoxylates, sorbitan ester ethoxylates, sulphosuccinate, calcium salts of dodecylbenzene sulphonate, alkylammonium salts of alkylbenzene sulphonate, alkylsulphosuccinate salts, ethylene oxide-propylene oxide block copolymers, ethoxylated alkylamines, ethoxylated alkyl phenols, polyoxyethylene sorbitan monolaurate present in an amount of 5%-30% by weight

9. The synergistic Oil Dispersion agrochemical formulation as claimed in claim 7, wherein dispersing agent is selected from alkyl sulfonates, alkyl benzene sulfonates, alkyl aryl sulfonates, alkylphenolalkoxylates, tristyrylphenol ethoxylates, natural or synthetic fatty ethoxylate alcohols, natural or synthetic fatty acid alkoxylates, natural or synthetic fatty alcohols alkoxylates, alkoxylated alcohols (such as n-butyl alcohol poly glycol ether), block copolymers (such as ethylene oxide-propylene oxide block copolymers and ethylene oxide-butylene oxide block copolymers), fatty acid-polyalkylene glycol condensates, polyamine-fatty acid condensates, polyester condensates, salts of polyolefin condensates, sodium ligno sulfonate, sodium ploycarboxylate, EO/PO based copolymer, phenol sulfonate, sodium methyl oleoyl taurate, acrylic copolymer blend, styrene acrylic acid copolymer, propyleneoxide-ethyleneoxide-copolymer, polyethylene glycol 2,4,6-tristyrylphenyl ether, tristyrylphenol-polyglycolether-phosphate, tristyrylphenole with 16 moles EO, tristyrylphenol-polyglycolether-phosphate, oleyl-polyglycolether with ethylene oxide, tallow fattyamine polyethylene oxide, nonylphenol polyglycolether with 9-10 moles ethylene oxide present in an amount of 1%-10% by weight

10. The synergistic Oil Dispersion agrochemical formulation as claimed in claim 7, wherein stabilizer is selected from hectorite clay, aluminium magnesium silicate, bentonite clay, silica, silicon dioxide, attapulgite clay present in an amount of 0.1%-4% by weight

11. The synergistic Oil Dispersion agrochemical formulation as claimed in claim 7, wherein antifoaming agent is selected from silicone oil, silicone compound, C10˜C20 saturated fat acid compounds or C8˜C10 aliphatic alcohols compound, silicone antifoam emulsion, dimethylsiloxane, polydimethyl siloxane, vegetable oil based antifoam, tallow based fatty acids, polyalkyleneoxide modified polydimethylsiloxane present in an amount of 0.01%-2% by weight

12. The synergistic Oil Dispersion agrochemical formulation as claimed in claim 7, wherein anti-freezing agent is selected from ethylene glycol, propane diols, glycerine or the urea, glycol (Monoethylene glycol, Diethylene glycol, Propylene glycol, Polypropylene glycol, Polyethylene glycol), glycerine, urea, magnesium sulfate heptahydrate, sodium chloride present in an amount of 0.5%-10% by weight.

13. The synergistic Oil Dispersion agrochemical formulation as claimed in claim 7, wherein Preservative is selected from 1,2-benzisothiazolin-3(2H)-one, sodium salt, sodium benzoate, 2-bromo-2-nitropropane-1,3-diol, formaldehyde, sodium o-phenylphenate, 5-chloro-2-methyl-4-isothiazolin-3-one & 2-methyl-4-isothiazolin-3-one present in an amount of 0.1%-4% by weight

14. The synergistic Oil Dispersion agrochemical formulation as claimed in claim 7, wherein buffering agnet is selected Citric acid, sodium carbonate, sodium bicarbonate, sulphuric acid, hydrochloric acid, sodium hydroxide, potassium hydroxide, acetic acid, sorbic acid present in an amount of 0.1%-4% by weight.

15. The synergistic Oil Dispersion agrochemical formulation as claimed in claim 2, wherein an insecticide is selected from class of Carbamates; Organophosphates; Phenylpyrazole; Pyrethroids; Nicotinic insecticides; Spinosyns; Mectins; Juvenile hormone mimics; Chordotonal organs modulators; Mite growth inhibitors; Microbial disruptors of insect midgut membrane; Inhibitors of mitochondrial ATP synthase; Uncouplers of oxidative phosphorylation; Chitin biosynthesis inhibitors; Inhibitors of the chitin biosynthesis type 1; Moulting disruptors; Ecdyson receptor agonists; Octopamin receptor agonists; METI (mitochondrial electron transport inhibitors; Voltage-dependent sodium channel blockers; Inhibitors of the lipid synthesis, inhibitors of acetyl CoA carboxylase; Diamides; Metadiamides; Isoxazolines; Baculoviruses; compounds of unknown or uncertain mode of action.

16. The synergistic Oil Dispersion agrochemical formulation as claimed in claim 2, wherein a fungicide compound is selected from class of Nucleic acid synthesis inhibitors; Cytoskeleton and motor proteins/cell division Inhibitors; Respiration inhibitors; Amino acids and protein synthesis inhibitors; Signal transduction inhibitors; Lipid or transport and membrane synthesis inhibitors; Sterol biosynthesis Inhibitors; Cell wall biosynthesis Inhibitors; Melanin synthesis in cell wall Inhibitors; Plant defence inducers; Unknown mode of action; Not classified (N); Chemicals with multisite activities (M)—multisite contact activities.

17. The synergistic Oil Dispersion agrochemical formulation as claimed in claim 2, wherein a herbicide compound is selected from class of Inhibitor of Acetyl CoA Carboxylase (ACCase); Inhibitor of Acetolactate Synthase (ALS) or Acetohydroxy Acid Synthase (AHAS); Inhibitor of microtubule assembly; Synthetic Auxin; Inhibitor of photosynthesis at photosystem II site A; Inhibitor of photosynthesis at photosystem II site B; Inhibitor of photosynthesis at photosystem II site A; different behavior from group 5; Inhibitor of lipid synthesis; not ACCase inhibition; Inhibitor of 5-enolypyruvyl-shikimate-3-phosphate synthase (EPSPS): Glycine; Inhibitor of glutamine synthetase: Phosphonic acid; Inhibitor of phytoene desaturase (PDS); Inhibitor of 1-deoxy-D-xyulose 5-phosphate synthatase (DOXP synthase); Inhibitor of protoporphyrinogen oxidase (Protox, PPO); Mitosis Inhibitor; Inhibitor of 7,8-dihydro-preroate synthetase (DHP); Inhibitor of indoleacetic acid transport; Inhibitor of cell wall synthesis site A; Inhibitor of cell wall synthesis site B; Inhibitor of cell wall synthesis site C; Inhibition of cellulose synthesis; Photosystem I electron diverter; Membrane disruptor (uncouplers); Inhibitor of Hydroxyphenyl Pyruvate Dioxygenase (4-HPPD); Tyrosine Aminotransferase; Inhibition of dihydroorotate dehydrogenase (DHODH); HTS (homogentisate solanesyltransferase)—a downstream enzyme of HPPD; Very Long Chain Fatty Acid Inhibitors; Inhibition of lycopene cyclase; Inhibition of Solanesyl Diphosphate Synthase (SDS); Inhibition of serine-threonine protein phosphatase; Unknown mode of action.

18. The synergistic Oil Dispersion agrochemical formulation as claimed in claim 2, wherein a herbicide compound is selected from class of plant health additives are selected from bio-stimulants, plant growth regulators, microbial agents and micronutrients or mixture thereof.
